(19) United States
(12) Patent Application Publication
(10) Pub. No.: US 2024/0417647 A1
(43) Pub. Date: Dec. 19, 2024

(54) LOW 1,4 DIOXANE, FAST WETTING AND HIGH FOAMING CLEANING COMPOSITIONS AND METHODS OF USE THEREOF

(71) Applicant: ECOLAB USA INC., Saint Paul, MN (US)

(72) Inventors: Victor Fuk-Pong Man, Saint Paul, MN (US); Gang Pu, Saint Paul, MN (US); David Riehm, Saint Paul, MN (US); Edward J. Snodgrass, Saint Paul, MN (US)

(21) Appl. No.: 18/747,621

(22) Filed: Jun. 19, 2024

Related U.S. Application Data
(60) Provisional application No. 63/508,960, filed on Jun. 19, 2023.

(51) Int. Cl. C11D 1/83; C11D 1/12; C11D 1/44; C11D 1/72; C11D 3/00

(52) U.S. Cl. CPC C11D 1/83; C11D 1/123; C11D 1/44; C11D 1/72; C11D 3/0036; C11D 2111/14

(57) ABSTRACT

Fast wetting and high foaming cleaning compositions with a combination of anionic and nonionic surfactants are disclosed. The compositions include a low-1,4 dioxane, high foaming anionic surfactant in combination with a high foaming nonionic surfactant and at least one cosurfactant comprising a sulfosuccinate. Methods of cleaning with the fast wetting and high foaming cleaning compositions are also disclosed.

### CROSS REFERENCE TO RELATED APPLICATIONS

This application claims priority under 35 U.S.C. § 119 to provisional application Ser. No. 63/508,960, filed Jun. 19, 2023, herein incorporated by reference in its entirety.

### TECHNICAL FIELD

The disclosure relates generally to fast wetting and high foaming cleaning compositions with a combination of anionic and nonionic surfactants and at least one co-surfactant. More particularly, the compositions include a low-1,4 dioxane, high foaming anionic surfactant in combination with a high foaming nonionic alcohol ethoxylate or alcohol alkoxylate surfactant having between 4-10 EO groups and at least one cosurfactant comprising a sulfosuccinate, an amine oxide or alcohol ethoxylate surfactant having between 1-3 EO groups. Methods of cleaning with the fast wetting and high foaming cleaning compositions are also disclosed.

### BACKGROUND

Liquid and solid cleaning compositions utilize various combinations of surfactant packages to provide desired cleaning and other characteristics, such as detersive performance, high foaming and foam stability, product stability, user preference, user safety, environmental safety, and the like. There remains a need to adapt to changes in such formulation characteristics, including environmental safety, in light of changes relating to 1,4 dioxanes which are classified as contaminants by the U.S. Environmental Protection Agency. 1,4 dioxanes can be byproducts of and contained in certain surfactants and emulsifiers, and can also be detected in certain surfactants, such as alkyl ether sulfates.

Thus, there exists a need in the art for providing liquid and solid cleaning compositions that are low-1,4 dioxane or 1,4 dioxane-free while providing desired cleaning efficacy and other formulation characteristics. This presents a challenge as certain dioxane-containing surfactants, including alkyl ether sulfates, provide desired detersive performance, high foaming and foam stability and other characteristics.

It is therefore an object of this disclosure to provide compositions that are alkyl ether sulfate free.

It is a further object of the disclosure to provide fast wetting, high foaming, stable foam, high detergency, and cost effective cleaning compositions.

Other objects, embodiments and advantages of this disclosure will be apparent to one skilled in the art in view of the following disclosure, the drawings, and the appended claims.

### SUMMARY

It is a primary object, feature, and/or advantage of the present disclosure to improve on or overcome the deficiencies in the art in containing undesirable levels of 1,4 dioxanes through the inclusion of alkyl ether sulfates.

According to some aspects of the present disclosure, detergent compositions comprise: a high foaming anionic surfactant, wherein the anionic surfactant is a low-1,4 dioxane surfactant; a high foaming alcohol ethoxylate or alcohol alkoxylate surfactant having between 4-10 EO groups; one or more co-surfactants comprising a sulfosuccinate, an amine oxide or alcohol ethoxylate surfactant having between 1-3 EO groups, wherein the ratio of alcohol ethoxylate or alcohol alkoxylate surfactant having between 4-10 EO groups to the alcohol ethoxylate surfactant having between 1-3 EO groups is from about 1:1 to about 10:1, and wherein the detergent composition is a solid or liquid, high foaming and wetting detergent that is resistant to soil and mitigates 1,4 dioxane.

According to some other aspects of the present disclosure, methods of using a 1,4 dioxane mitigated solid or liquid detergent composition comprise: generating a use solution of the solid or liquid compositions as described herein; and contacting an article or surface in need of cleaning with the use solution.

These and/or other objects, features, advantages, aspects, and/or embodiments will become apparent to those skilled in the art after reviewing the following brief and detailed descriptions of the drawings. Furthermore, the present disclosure encompasses aspects and/or embodiments not expressly disclosed but which can be understood from a reading of the present disclosure, including at least: (a) combinations of disclosed aspects and/or embodiments and/or (b) reasonable modifications not shown or described.

While multiple embodiments are disclosed, still other embodiments will become apparent to those skilled in the art from the following detailed description, which shows and describes illustrative embodiments. Accordingly, the drawings and detailed description are to be regarded as illustrative in nature and not restrictive.

### BRIEF DESCRIPTION OF THE DRAWINGS

Several embodiments in which the present disclosure can be practiced are illustrated and described in detail, wherein like reference characters represent like components throughout the several views. The drawings are presented for exemplary purposes and may not be to scale unless otherwise indicated.

FIG. 1 is a graph showing the contact angle of detergent compositions comprising various amounts of Colotrope, Silwet, and Succinate compared to an inline compositions.

FIG. 2 is a graph showing the contact angle of an inline composition with 0%, 6%, and 8% of succinate.

FIG. 3 is a graph showing the foam volume (in mL) (y-axis) to the number of soil drops of a 1.5 g/L inline and experimental mixing composition #26 in 25° C. with 5 grain water.

FIG. 4 is a graph showing the foam volume (in mL) (y-axis) to the number of soil drops of a 1.5 g/L inline and experimental mixing composition #26 in 23° C. with 17 grain water.

FIG. 5 is a graph showing the foam volume (in mL) (y-axis) to the number of soil drops of a 1.5 g/L inline and experimental mixing composition #27 in 25° C. with 5 grain water.

FIG. 6 is a graph showing the foam volume (in mL) (y-axis) to the number of soil drops of a 1.5 g/L inline and 1.2 g/L experimental mixing composition #28 in 25° C. with 5 grain water.

FIG. 7 is a graph showing the foam volume (in mL) (y-axis) to the number of soil drops of a 1.5 g/L inline and 1.2 g/L experimental mixing composition #29 in 25° C. with 5 grain water.

FIG. 8 is a graph showing the foam volume (in mL) (y-axis) to the number of soil drops of a 1.5 g/L inline and experimental mixing composition #30 in 25° C. with 5 grain water.

FIG. 9 is a graph showing the foam volume (in mL) (y-axis) to the number of soil drops of a 1.5 g/L inline and experimental mixing composition #31 in 25° C. with 5 grain water.

FIG. 10 is a graph showing the foam volume (in mL) (y-axis) to the number of soil drops of a 1.5 g/L inline and experimental mixing composition #32 in 25° C. with 5 grain water.

FIG. 11 is a graph showing the foam volume (in mL) (y-axis) to the number of soil drops of a 1.5 g/L inline and experimental mixing composition #33 in 25° C. with 5 grain water.

FIG. 12 is a graph showing the foam volume (in mL) (y-axis) to the number of soil drops comparing inline and experimental averages tested at 1.5 g/L.

FIG. 13 is a graph showing the foam volume (in mL) (y-axis) to the number of soil drops comparing inline and experimental averages tested at 0.7 g/L.

FIG. 14 is a graph showing the foam volume (in mL) (y-axis) to the number of soil drops show enhanced foam volume for a cleaning composition compared to Inline Control even as soil increases to challenge the foam.

FIG. 15 is a graph showing the foam volume (in mL) (y-axis) to the number of soil drops show enhanced foam volume for a cleaning composition compared to Inline Control even as soil increases to challenge the foam.

FIG. 16 is a graph showing the foam volume (in mL) (y-axis) to the number of soil drops of a 1.5 g/L inline and experimental mixing composition #45 in 25° C. with 5 grain water.

FIG. 17 is a graph showing the foam volume (in mL) (y-axis) to the number of soil drops of a 1.5 g/L commercial control and experimental mixing composition #45 in 25° C. with 5 grain water.

FIG. 18 is a graph showing the foam volume (in mL) (y-axis) to the number of soil drops of a 1.5 g/L inline and experimental mixing composition #45 in 25° C. with 17 grain water.

FIG. 19 is a graph showing the foam volume (in mL) (y-axis) to the number of soil drops of a 1.5 g/L commercial control and experimental mixing composition #45 in 25° C. with 17 grain water.

FIG. 20 is a graph showing the foam volume (in mL) (y-axis) to the number of soil drops of a 1.5 g/L inline and experimental mixing composition #42 in 25° C. with 5 grain water.

Various embodiments of the present disclosure will be described in detail with reference to the drawings, wherein like reference numerals represent like parts throughout the several views. Reference to various embodiments does not limit the scope of the disclosure. Figures represented herein are not limitations to the various embodiments according to the disclosure and are presented for exemplary illustration of the invention. An artisan of ordinary skill in the art need not view, within isolated figure(s), the near infinite number of distinct permutations of features described in the following detailed description to facilitate an understanding of the present invention.

### DETAILED DESCRIPTION

The present disclosure is not to be limited to that described herein, which can vary and are understood by skilled artisans. No features shown or described are essential to permit basic operation of the present disclosure unless otherwise indicated. It has been surprisingly found that a combination of a high foaming anionic surfactant, wherein the anionic surfactant is low-1,4 dioxane or preferably 1,4 dioxane-free; a high foaming nonionic alcohol ethoxylate or alcohol alkoxylate surfactant having between 4-10 EO groups, and one or more co-surfactants provide a solid or liquid, high foaming and wetting detergent that mitigates 1,4 dioxane.

It is further to be understood that all terminology used herein is for the purpose of describing particular embodiments only, and is not intended to be limiting in any manner or scope. For example, as used in this specification and the appended claims, the singular forms “a,” “an” and “the” can include plural referents unless the content clearly indicates otherwise. Further, all units, prefixes, and symbols may be denoted in its SI accepted form.

Numeric ranges recited within the specification are inclusive of the numbers defining the range and include each integer within the defined range. Throughout this disclosure, various aspects of this disclosure are presented in a range format. It should be understood that the description in range format is merely for convenience and brevity and should not be construed as an inflexible limitation on the scope of the disclosure. Accordingly, the description of a range should be considered to have specifically disclosed all the possible sub-ranges, fractions, and individual numerical values within that range. For example, description of a range such as from 1 to 6 should be considered to have specifically disclosed sub-ranges such as from 1 to 3, from 1 to 4, from 1 to 5, from 2 to 4, from 2 to 6, from 3 to 6 etc., as well as individual numbers within that range, for example, 1, 2, 3, 4, 5, and 6, and decimals and fractions, for example, 1.2, 3.8, 1½, and 4¾. This applies regardless of the breadth of the range.

As used herein, the term “and/or”, e.g., “X and/or Y” shall be understood to mean either “X and Y” or “X or Y” and shall be taken to provide explicit support for both meanings or for either meaning, e.g. A and/or B includes the options i) A, ii) B or iii) A and B.

It is to be appreciated that certain features that are, for clarity, described herein in the context of separate embodiments, may also be provided in combination in a single embodiment. Conversely, various features that are, for brevity, described in the context of a single embodiment, may also be provided separately or in any sub-combination.

The methods and compositions of the present disclosure may comprise, consist essentially of, or consist of the components and ingredients of the present disclosure as well as other ingredients described herein. As used herein, “consisting essentially of” means that the methods, systems, apparatuses and compositions may include additional steps, components or ingredients, but only if the additional steps, components or ingredients do not materially alter the basic and novel characteristics of the claimed methods, systems, apparatuses, and compositions.

Unless defined otherwise, all technical and scientific terms used above have the same meaning as commonly understood by one of ordinary skill in the art to which embodiments of the present disclosure pertain.

The terms “invention” or “present invention” are not intended to refer to any single embodiment of the particular invention but encompass all possible embodiments as described in the specification and the claims.

The term “about,” as used herein, refers to variation in the numerical quantity that can occur, for example, through typical measuring techniques and equipment, with respect to any quantifiable variable, including, but not limited to, concentration, mass, volume, time, surface tension, molecular weight, contact angle, temperature, pH, humidity, molar ratios, log counts, and the like. Further, given solid and liquid handling procedures used in the real world, there is certain inadvertent error and variation that is likely through differences in the manufacture, source, or purity of the ingredients used to make the compositions or carry out the methods and the like. The term “about” also encompasses these variations. Whether or not modified by the term “about,” the claims include equivalents to the quantities.

The term “actives” or “percent actives” or “percent by weight actives” or “actives concentration” are used interchangeably herein and refers to the concentration of those ingredients involved in cleaning expressed as a percentage minus inert ingredients such as water or salts. It is also sometimes indicated by a percentage in parentheses, for example, “chemical (10%).”

As used herein, the term “alkyl” or “alkyl groups” refers to saturated hydrocarbons having one or more carbon atoms, including straight-chain alkyl groups (e.g., methyl, ethyl, propyl, butyl, pentyl, hexyl, heptyl, octyl, nonyl, decyl, etc.), cyclic alkyl groups (or “cycloalkyl” or “alicyclic” or “carbocyclic” groups) (e.g., cyclopropyl, cyclopentyl, cyclohexyl, cycloheptyl, cyclooctyl, etc.), branched-chain alkyl groups (e.g., isopropyl, tert-butyl, sec-butyl, isobutyl, etc.), and alkyl-substituted alkyl groups (e.g., alkyl-substituted cycloalkyl groups and cycloalkyl-substituted alkyl groups). Unless otherwise specified, the term “alkyl” includes both “unsubstituted alkyls” and “substituted alkyls.” As used herein, the term “substituted alkyls” refers to alkyl groups having substituents replacing one or more hydrogens on one or more carbons of the hydrocarbon backbone. Such substituents may include, for example, alkenyl, alkynyl, halogeno, hydroxyl, alkylcarbonyloxy, arylcarbonyloxy, alkoxycarbonyloxy, aryloxy, aryloxycarbonyloxy, carboxylate, alkylcarbonyl, arylcarbonyl, alkoxycarbonyl, aminocarbonyl, alkylaminocarbonyl, dialkylaminocarbonyl, alkylthiocarbonyl, alkoxyl, phosphate, phosphonato, phosphinato, cyano, amino (including alkyl amino, dialkylamino, arylamino, diarylamino, and alkylarylamino), acylamino (including alkylcarbonylamino, arylcarbonylamino, carbamoyl and ureido), imino, sulfhydryl, alkylthio, arylthio, thiocarboxylate, sulfates, alkylsulfinyl, sulfonates, sulfamoyl, sulfonamido, nitro, trifluoromethyl, cyano, azido, heterocyclic, alkylaryl, or aromatic (including heteroaromatic) groups.

In some embodiments, substituted alkyls can include a heterocyclic group. As used herein, the term “heterocyclic group” includes closed ring structures analogous to carbocyclic groups in which one or more of the carbon atoms in the ring is an element other than carbon, for example, nitrogen, sulfur or oxygen. Heterocyclic groups may be saturated or unsaturated. Exemplary heterocyclic groups include, but are not limited to, aziridine, ethylene oxide (epoxides, oxiranes), thiirane (episulfides), dioxirane, azetidine, oxetane, thietane, dioxetane, dithietane, dithiete, azolidine, pyrrolidine, pyrroline, oxolane, dihydrofuran, and furan.

As used herein, the term “antimicrobial” refers to a compound or composition that reduces and/or inactivates a microbial population, including, but not limited to bacteria, viruses, fungi, and algae within about 10 minutes or less, about 8 minutes or less, about 5 minutes or less, about 3 minutes or less, about 2 minutes or less, about 1 minute or less, or about 30 seconds or less. Preferably, the term antimicrobial refers to a composition that provides at least about a 3-log, 3.5 log, 4 log, 4.5 log, or 5 log reduction of a microbial population in about 10 minutes or less, about 8 minutes or less, about 5 minutes or less, about 3 minutes or less, about 2 minutes or less, about 1 minute or less, or about 30 seconds or less.

As used herein, the term “cleaning” refers to a method used to facilitate or aid in soil removal, bleaching, microbial population reduction, and any combination thereof. As used herein, the term “microorganism” refers to any noncellular or unicellular (including colonial) organism. Microorganisms include all prokaryotes. Microorganisms include bacteria (including cyanobacteria), spores, lichens, fungi, protozoa, virinos, viroids, viruses, phages, and some algae. As used herein, the term “microbe” is synonymous with microorganism.

The term “configured” describes structure capable of performing a task or adopting a particular configuration. The term “configured” can be used interchangeably with other similar phrases, such as constructed, arranged, adapted, manufactured, and the like.

Terms characterizing sequential order, a position, and/or an orientation are not limiting and are only referenced according to the views presented.

As used herein, the term “exemplary” refers to an example, an instance, or an illustration, and does not indicate a most preferred embodiment unless otherwise stated.

The term “generally” encompasses both “about” and “substantially.”

As used herein, the term “microorganism” refers to any noncellular or unicellular (including colonial) organism. Microorganisms include all prokaryotes. Microorganisms include bacteria (including cyanobacteria), spores, lichens, fungi, protozoa, virinos, viroids, viruses, phages, and some algae. As used herein, the term “microbe” is synonymous with microorganism.

As used herein the term “polymer” refers to a molecular complex comprised of a more than ten monomeric units and generally includes, but is not limited to, homopolymers, copolymers, such as for example, block, graft, random and alternating copolymers, terpolymers, and higher “x”mers, further including their analogs, derivatives, combinations, and blends thereof. Furthermore, unless otherwise specifically limited, the term “polymer” shall include all possible isomeric configurations of the molecule, including, but are not limited to isotactic, syndiotactic and random symmetries, and combinations thereof. Furthermore, unless otherwise specifically limited, the term “polymer” shall include all possible geometrical configurations of the molecule.

As used herein, the term “sanitizer” refers to an agent that reduces the number of bacterial contaminants to safe levels as judged by public health requirements. In an embodiment, sanitizers for use in this invention will provide at least a 99.999% reduction (5-log order reduction). These reductions can be evaluated using a procedure set out in Germicidal and Detergent Sanitizing Action of Disinfectants, Official Methods of Analysis of the Association of Official Analytical Chemists, paragraph 960.09 and applicable sections, 15th Edition, 1990 (EPA Guideline 91-2). According to this reference a sanitizer should provide a 99.999% reduction (5-log order reduction) within 30 seconds at room temperature, 25±2° C., against several test organisms.

As used herein, the term “soil” or “stain” refers to any soil, including, but not limited to, non-polar oily and/or hydrophobic substances which may or may not contain particulate matter such as industrial soils, mineral clays, sand, natural mineral matter, carbon black, graphite, kaolin, environmental dust, and/or food based soils such as blood, proteinaceous soils, starchy soils, fatty soils, cellulosic soils, etc.

The “scope” of the present disclosure is defined by the appended claims, along with the full scope of equivalents to which such claims are entitled. The scope of the disclosure is further qualified as including any possible modification to any of the aspects and/or embodiments disclosed herein which would result in other embodiments, combinations, subcombinations, or the like that would be obvious to those skilled in the art.

The term “substantially” refers to a great or significant extent. “Substantially” can thus refer to a plurality, majority, and/or a supermajority of said quantifiable variable, given proper context.

As used herein, the term “substantially free” refers to compositions completely lacking the component or having such a small amount of the component that the component does not affect the performance of the composition. The component may be present as an impurity or as a contaminant and shall be less than 0.5 wt-%. In another embodiment, the amount of the component is less than 0.1 wt-% and in yet another embodiment, the amount of component is less than 0.01 wt-%.

The term “surfactant” or “surface active agent” refers to an organic chemical that when added to a liquid changes the properties of that liquid at a surface.

As used herein, the term “ware” refers to items such as eating and cooking utensils, dishes, and other hard surfaces such as showers, sinks, toilets, bathtubs, countertops, windows, mirrors, transportation vehicles, and floors. As used herein, the term “warewashing” refers to washing, cleaning, or rinsing ware. Ware also refers to items made of plastic. Types of plastics that can be cleaned with the compositions include but are not limited to, those that include polypropylene polymers (PP), polycarbonate polymers (PC), melamine formaldehyde resins or melamine resin (melamine), acrylonitrile-butadiene-styrene polymers (ABS), and polysulfone polymers (PS). Other exemplary plastics that can be cleaned using the compounds and compositions of the disclosure include polyethylene terephthalate (PET) polystyrene polyamide.

The term “weight percent,” “wt-%,” “percent by weight,” “% by weight,” and variations thereof, as used herein, refer to the concentration of a substance as the weight of that substance divided by the total weight of the composition and multiplied by 100. It is understood that, as used here, “percent,” “%,” and the like are intended to be synonymous with “weight percent,” “wt-%,” etc.

### Cleaning Compositions

According to embodiments, the cleaning compositions include high foaming anionic surfactant, high foaming nonionic surfactant, and one or more co-surfactants comprising a sulfosuccinate, an amine oxide and/or alcohol ethoxylate surfactant. The cleaning compositions are SLES-free surfactant blends providing low 1,4-dioxane containing compositions. The cleaning compositions can include additional functional ingredients and can be provided as liquid or solids compositions. Exemplary compositions are shown in Table 1 in weight percentage. While the components may have a percent actives of 100%, it is noted that Table 1 does not recite the percent actives of the components, but rather, recites the total weight percentage of the raw materials (i.e. active concentration plus inert ingredients).

TABLE 1

| | First | Second | Third |
|---|---|---|---|
| | Exemplary | Exemplary | Exemplary |
| Material | Range wt.-% | Range wt.-% | Range wt.-% |
| High foaming anionic | 0.5-60 | 1-50 | 1-40 |
| surfactant | | | |
| High foaming nonionic | 0.1-25 | 0.5-20 | 0.5-15 |
| surfactant | | | |
| Co-Surfactant(s) | 0.1-20 | 0.2-15 | 0.3-10 |
| Additional Functional | 0-50 | 0-40 | 0-30 |
| Ingredients | | | |

The compositions provide the 1,4-dioxane reduction while also providing desired performance benefits such as better wetting, higher foam, higher detergency, lower CMC (critical micelle concentration), and lower surface tension resulting from the surfactant compositions, namely the combination of the high foaming anionic surfactant, high foaming nonionic surfactant, and one or more co-surfactants. Without being limited to a particular mechanism of action, the combination of surfactants provides efficient and improved interfacial packing by the surfactants compared to conventional control products containing SLES in a surfactant composition. For example, conventional high foaming and performance products (e.g. pot-and-pan compositions) have a predominant actives concentration of high foaming anionic surfactant (e.g., LS, LES, AOS) with large effective hydrodynamic cross-sectional area for its hydrophilic heads and very small effective hydrodynamic cross-sectional area for its hydrophobic tail. The same is true for compositions with nonionic surfactants (alcohol ethoxylates, APG, CocoDEA). Either of these surfactant packages alone and combinations thereof have been unable to have efficient surfactant packing at the interfaces. The compositions and combination of surfactants described herein overcome these limitations.

In addition, the compositions overcome limitations of anionic surfactants that are strongly affected by electrolyte concentration, especially hard water salts (e.g. Ca and Mg), in a detergent use solution. The Krafft temperatures of various anionic surfactants are also a factor in composition performance. The Krafft temperature is the temperature below which an anionic surfactant has very low solubility and cannot form micelles, unless aided by other more soluble surfactants. In comparing various anionic surfactants the temperatures are AOS>DOSS>SLS>SLES, indicating that SLES is a preferred anionic surfactant for performance as it is least impacted by temperature solubility and ability for form micelles. Although alternative anionic surfactants are more susceptible to performance changes based on temperature, the surfactant compositions described herein overcomes this limitation.

### Anionic Surfactant

The cleaning compositions include a high foaming anionic surfactant. Anionic surfactants are surface active substances which are categorized by the negative charge on the hydrophobe; or surfactants in which the hydrophobic section of the molecule carries no charge unless the pH is elevated to neutrality or above (e.g. carboxylic acids). Carboxylate, sulfonate, sulfate and phosphate are the polar (hydrophilic) solubilizing groups found in anionic surfactants. Of the cations (counter ions) associated with these polar groups, sodium, lithium and potassium impart water solubility; ammonium and substituted ammonium ions provide both water and oil solubility; and, calcium, barium, and magnesium promote oil solubility.

The high foaming anionic surfactant is a low-1,4 dioxane surfactant. As referred to herein, low-1,4 dioxane means that the solid or liquid composition comprising the high foaming anionic surfactant generates less than about 1 ppm 1,4 dioxane in a use solution. In embodiments it can be challenging to ensure a 1,4 dioxane-free composition as dioxanes can still be found as contaminants in processing of various raw materials. In a preferred embodiment, the anionic surfactant does not include or is free of alkyl ether sulfates, namely Lauryl Ether Sulfate (LES) and Sodium Lauryl Ether Sulfate (SLES).

Anionic surfactants that are high foaming and suitable for use in the cleaning compositions include alkyl sulfonates, alkyl sulfates, and alpha olefin sulfonates. In an embodiment the anionic sulfonate surfactant is an alpha olefin sulfonate or its salts. Alpha olefin sulfonates are available as aqueous solutions, powders or as a solid anhydrous product. Preferred anionic sulfonates include C8-C22 alpha olefin sulfonates, or C8-C16 alpha olefin sulfonates.

Anionic sulfonate surfactants suitable for use in the compositions also include alkyl sulfonates, the linear and branched primary and secondary alkyl sulfonates, and the aromatic sulfonates with or without substituents. In an aspect, sulfonates include sulfonated carboxylic acid esters. In an aspect, suitable alkyl sulfonate surfactants include C8-C22 alkyl sulfonates, or preferably C10-C22 alkyl sulfonates. A preferred anionic sulfonate surfactant is the alkyl olefin sulfonate Alpha Olefin Sulfonate (AOS).

Anionic sulfate surfactants suitable for use in the compositions also include alkyl sulfates, the linear and branched primary and secondary alkyl sulfates, alkyl benzene sulfonates (e.g. sodium alkyl benzene sulfonates including sodium dodecylbenzenesulfonate), alkyl ethoxysulfates, fatty oleyl glycerol sulfates, alkyl phenol ethylene oxide ether sulfates, the C₅-C₁₇ acyl-N—(C₁-C₄ alkyl) and —N—(C₁-C₂ hydroxyalkyl) glucamine sulfates, and sulfates of alkylpolysaccharides such as the sulfates of alkylpolyglucoside, and the like. Also included are the alkyl sulfates, alkyl poly(ethyleneoxy) ether sulfates and aromatic poly(ethyleneoxy) sulfates such as the sulfates or condensation products of ethylene oxide and nonyl phenol (usually having 1 to 6 oxyethylene groups per molecule). A preferred alkyl sulfate is sodium lauryl sulfate (SLS) or a branched sodium lauryl sulfate (SLS) commercially available as Safol 23E70.

Alternative anionic surfactants suitable for the compositions include anionic carboxylate surfactants, those which have a carboxylic acid or an alpha hydroxyl acid group. Anionic carboxylate surfactants suitable for use in the compositions also include carboxylic acids (and salts), such as alkanoic acids (and alkanoates), ester carboxylic acids (including sulfonated carboxylic acid esters), ether carboxylic acids, sulfonated fatty acids, such as sulfonated oleic acid, and the like. In an aspect, suitable ester carboxylic acids include alkyl succinates, such as for example dioctyl sulfosuccinate. Such carboxylates include alkyl ethoxy carboxylates, alkyl aryl ethoxy carboxylates, alkyl polyethoxy polycarboxylate surfactants and soaps (e.g. alkyl carboxyls). Secondary carboxylates useful in the compositions include those which contain a carboxyl unit connected to a secondary carbon. The secondary carbon can be in a ring structure, e.g. as in p-octyl benzoic acid, or as in alkyl-substituted cyclohexyl carboxylates. The secondary carboxylate surfactants typically contain no ether linkages, no ester linkages and no hydroxyl groups. Further, they typically lack nitrogen atoms in the head-group (amphiphilic portion). Suitable secondary surfactants typically contain 11-13 total carbon atoms, although more carbons atoms (e.g., up to 16) can be present. Suitable carboxylates also include acylamino acids (and salts), such as acylgluamates, acyl peptides, sarcosinates (e.g. N-acyl sarcosinates), taurates (e.g. N-acyl taurates and fatty acid amides of methyl tauride), and the like.

Suitable anionic surfactants include alkyl or alkylaryl ethoxy carboxylates of the following formula:

R—O—(CH₂CH₂O)ₙ(CH₂)ₘ—CO₂X (3)

in which R is a C₈ to C₂₂ alkyl group or

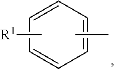

in which R¹ is a C₄-C₁₆ alkyl group; n is an integer of 1-20; m is an integer of 1-3; and X is a counter ion, such as hydrogen, sodium, potassium, lithium, ammonium, or an amine salt such as monoethanolamine, diethanolamine or triethanolamine. In some embodiments, n is an integer of 4 to 10 and m is 1. In some embodiments, R is a C₈-C₁₆ alkyl group. In some embodiments, R is a C₁₂-C₁₄ alkyl group, n is 4, and m is 1.

In other embodiments, R is

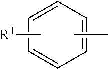

and R¹ is a C₆-C₁₂ alkyl group. In still yet other embodiments, R¹ is a C₉ alkyl group, n is 10 and m is 1.

Another class of anionic surfactant include the alpha sulfonated carboxylic acid esters, such as MC or PC-48 from Stepan.

In some embodiments, the anionic surfactant is included in the composition at an amount of at least about 0.5 wt-% to about 60 wt-%, about 1 wt-% to about 50 wt-%, about 1 wt-% to about 40 wt-%, about 1 wt-% to about 30 wt-%, or about 5 wt-% to about 30 wt-%. In addition, without being limited according to the disclosure, all ranges recited are inclusive of the numbers defining the range and include each integer within the defined range.

### Nonionic Surfactant

The cleaning compositions include a high foaming nonionic surfactant comprising an alcohol ethoxylate or alcohol alkoxylate surfactant having between 4-10 EO groups. Alcohol alkoxylates are nonionic surfactants which are ethoxylated and/or propoxylated such as those having the formula R(OC₂H₄)ₓ(OC₃H₆) y where R is an alkyl or alkenyl group, such as C6-C22, x is 0 to 18, preferably 1 to 18, y is 0 to 10, preferably 1 to 10 and in embodiments the sum of x and y is at least 5.

Alcohol ethoxylates are a type of alcohol alkoxylates that contain a hydrophobic alkyl chain attached via an ether linkage to a hydrophilic ethylene oxide (EO) chain and have the general structure R(OCH₂CH₂)ₙOH. The alkyl chain, R, can vary in length and in the degree of linearity, and is preferably between about 8 and 18 carbons long, or between about 9 and 12 carbons long. Although EO chain in alcohol ethoxylates can also vary in length from 1 to 40 EO units, the high foaming nonionic surfactant has between 4-10 EO groups and are predominantly linear. As referred to herein, predominantly linear refers to 50% or greater linear structure. In some embodiments, the high foaming nonionic surfactant has between 4-10 EO groups and at least 60%, 70%, or 80% linear. In the general description of an alcohol ethoxylate a mixture of homologues can be present.

In some embodiments, the nonionic surfactant is included in the composition at an amount of at least about 0.1 wt-% to about 25 wt-%, about 0.1 wt-% to about 20 wt-%, about 0.5 wt-% to about 20 wt-%, or about 0.5 wt-% to about 15 wt-%. In addition, without being limited according to the disclosure, all ranges recited are inclusive of the numbers defining the range and include each integer within the defined range.

In preferred embodiments, the active weight percentage of nonionic surfactant exceeds the active weight percentage of anionic surfactant. In embodiments, nonionic surfactant can include the high foaming nonionic surfactant comprising an alcohol ethoxylate or alcohol alkoxylate surfactant having between 4-10 EO groups and optionally a nonionic co-surfactant.

### Co-Surfactants

The cleaning compositions include one or more co-surfactants including at least one of a sulfosuccinate, an amine oxide, alcohol ethoxylate surfactant having between 1-3 EO groups, PEG-modified castor oil, or combinations thereof.

In embodiments including a sulfosuccinate as a co-surfactant, a dialkyl sulfosuccinate is preferred. The dialkyl sulfosuccinate may be a C6-C15 linear or branched dialkyl sulfosuccinate. The alkyl moiety may be symmetrical or asymmetrical, referring to have the same or different alkyl moieties, respectively. Preferably, the alkyl moiety is symmetrical. An exemplary dialkyl sulfosuccinate is dioctyl sulfosuccinate (DOSS). A further exemplary dialkyl sulfosuccinate is dioctyl sulfosuccinate [di-(2 ethylhexyl) sodium sulfosuccinate and corresponding dihexyl and dioctyl esters. In an exemplary embodiment, the co-surfactant is a dioctyl sulfosuccinate (DOSS).

In embodiments including an amine oxide as a co-surfactant, it is understood that amine oxides are tertiary amine oxides corresponding to the general formula:

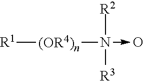

wherein the arrow is a conventional representation of a semi-polar bond; and, R¹, R², and R³ may be aliphatic, aromatic, heterocyclic, alicyclic, or combinations thereof. Generally, for amine oxides of detergent interest, R¹ is an alkyl radical of from about 8 to about 24 carbon atoms; R² and R³ are alkyl or hydroxyalkyl of 1-3 carbon atoms or a mixture thereof; R² and R³ can be attached to each other, e.g. through an oxygen or nitrogen atom, to form a ring structure; R⁴ is an alkaline or a hydroxyalkylene group containing 2 to 3 carbon atoms; and n ranges from 0 to about 20.

Exemplary amine oxides include dimethyl amine oxides, such as lauryl dimethyl amine oxide, myristyl dimethyl amine oxide, cetyl dimethyl amine oxide, combinations thereof, and the like. Useful water-soluble amine oxide surfactants are selected from the octyl, decyl, dodecyl, isododecyl, coconut, or tallow alkyl di-(lower alkyl) amine oxides, specific examples of which are octyl dimethyl amine oxide, nonyl dimethyl amine oxide, decyl dimethyl amine oxide, undecyl dimethyl amine oxide, dodecyldimethyl amine oxide, iso-dodecyldimethyl amine oxide, lauryl dimethyl amine oxide (sold commercially as Barlox 12), tridecyldimethylamine oxide, tetradecyldimethylamine oxide, pentadecyldimethylamine oxide, hexadecyldimethylamine oxide, heptadecyldimethylamine oxide, octadecyldimethylaine oxide, dodecyldipropylamine oxide, tetradecyldipropylamine oxide, hexadecyldipropylamine oxide, tetradecyldibutylamine oxide, octadecyldibutylamine oxide, bis(2-hydroxyethyl) dodecylamine oxide, bis(2-hydroxyethyl)-3-dodecoxy-1-hydroxypropylamine oxide, dimethyl-(2-hydroxydodecyl)amine oxide, 3,6,9-trioctadecyldimethylamine oxide and 3-dodecoxy-2-hydroxypropyldi-(2-hydroxyethyl)amine oxide.

In embodiments, the co-surfactant can include an alkyl amine oxide, lauric MEA, coco MEA, PEG-modified castor oil, and combinations thereof. Alkyl amine oxides can have a carbon length of about C10-C16. In an exemplary embodiment, the co-surfactant is a C12 alkyl amine oxide, such as lauryl dimethyl amine oxide (sold commercially as Barlox 12). Various amine oxides are provided as granulated surfactants.

In embodiments where the co-surfactant is an amine oxide, the ratio of anionic surfactant to the amine oxide is greater than 1:1, or about 2:1 to 4:1.

In embodiments where a combination of co-surfactants are employed, they can include for example a sulfosuccinate and amine oxide. In exemplary embodiments, the ratio of sulfosuccinate co-surfactant to a second co-surfactant, preferably the amine oxide, is from about 9:1 to about 3:7 on a weight basis, or from about 21:1 to about 1:1 on an actives basis.

In embodiments including an alcohol ethoxylate surfactant as a co-surfactant, the nonionic alcohol ethoxylate surfactant has between 1-3 EO groups with the general structure R(OCH₂CH₂)ₙOH. The alcohol ethoxylate is alkyl chain, R, can vary in length and in the degree of linearity, and is preferably between about 8 and 18 carbons long, or between about 9 and 12 carbons long, with the 1-3 EO groups and is predominantly linear. As referred to herein, predominantly linear refers to 50% or greater linear structure. In some embodiments, the co-surfactant has between 1-3 EO groups and is at least 60%, 70%, or 80% linear. In the general description of an alcohol ethoxylate a mixture of homologues can be present.

In embodiments, the ratio of alcohol ethoxylate or alcohol alkoxylate surfactant having between 4-10 EO groups to the alcohol ethoxylate co-surfactant having between 1-3 EO groups is from about 1:1 to about 10:1, wherein the ratio can be adjusted in consideration of the viscosity of the composition. In some embodiments, the ratio of alcohol ethoxylate or alcohol alkoxylate surfactant having between 4-10 EO groups to the alcohol ethoxylate co-surfactant having between 1-3 EO groups is from about 5:1 to about 2:1, or from about 5:1 to about 4:1.

In some embodiments, the co-surfactant(s) is included in the composition at an amount of at least about 0.1 wt-% to about 20 wt-%, about 0.2 wt-% to about 15 wt-%, or about 0.3 wt-% to about 10 wt-%. In addition, without being limited according to the disclosure, all ranges recited are inclusive of the numbers defining the range and include each integer within the defined range.

### Additional Functional Ingredients

The components of the cleaning composition can further be combined with various functional components suitable for uses disclosed herein, including heavy duty and manual detergents, including pot-and-pan applications. However as additional applications of use are envisioned, including any low 1,4-dioxane foaming composition other additional functional ingredients may be included for hand soaps, foaming cleaning, etc. In some embodiments, the cleaning compositions including the high foaming anionic surfactant, high foaming nonionic surfactant, and one or more co-surfactants make up a large amount, or even substantially all of the total weight of the compositions along with either a liquid or solid forming component. For example, in some embodiments few or no additional functional ingredients are disposed therein.

In other embodiments, additional functional ingredients may be included in the compositions. The functional ingredients provide desired properties and functionalities to the compositions. For the purpose of this application, the term “functional ingredient” includes a material that when dispersed or dissolved in a use and/or concentrate solution, such as an aqueous solution, provides a beneficial property in a particular use. Some particular examples of functional materials are discussed in more detail below, although the particular materials discussed are given by way of example only, and a broad variety of other functional ingredients may be used. For example, many of the functional materials discussed below relate to materials used in cleaning. However, other embodiments may include functional ingredients for use in other applications.

In some embodiments, the compositions may include solvents or hardening agents, optical brighteners, anti-redeposition agents, bleaching agents, solubility modifiers, dispersants, metal protecting agents, soil antiredeposition agents, stabilizing agents, chelating agents, enzymes, aesthetic enhancing agents including fragrances and/or dyes, rheology and/or solubility modifiers or thickeners such as metal salts, hydrotropes or couplers, buffers, solvents, additional cleaning agents and the like.

According to embodiments of the disclosure, the various additional functional ingredients may be provided in a composition in the amount from about 0 wt-% and about 50 wt-%, from about 0 wt-% and about 40 wt-%, from about 0 wt-% and about 30 wt-%, from about 0.01 wt-% and about 50 wt-%, from about 0.1 wt-% and about 50 wt-%, from about 1 wt-% and about 50 wt-%, from about 1 wt-% and about 40 wt-%, from about 1 wt-% and about 30 wt-%, or from about 1 wt-% and about 20 wt-%. In addition, without being limited according to the disclosure, all ranges recited are inclusive of the numbers defining the range and include each integer within the defined range.

### Compositions

The compositions can include liquid or solid compositions. Liquid compositions can have a significant wt-% concentration of water and be provided in a solution or suspension with a measurable viscosity.

Solid composition may take forms including, but not limited to: an extruded, molded or formed solid pellet, block, tablet, powder, granule, flake; or the formed solid can thereafter be ground or formed into a powder, granule, or flake. In an exemplary embodiment, extruded pellet materials formed have a weight of between approximately 50 grams and approximately 250 grams, extruded solids have a weight of approximately 100 grams or greater, and solid blocks formed have a mass of between approximately 1 and approximately 10 kilograms. The solid compositions provide for a stabilized source of functional materials. In a preferred embodiment, the solid composition may be dissolved, for example, in an aqueous or other medium, to create a concentrated and/or use solution. The solution may be directed to a storage reservoir for later use and/or dilution or may be applied directly to a point of use.

In certain embodiments, the solid composition is provided in the form of a unit dose. A unit dose refers to a solid composition unit sized so that the entire unit is used during a single washing cycle. When the solid composition is provided as a unit dose, it can have a mass of about 1 g to about 50 g. In other embodiments, the composition can be a solid, a pellet, or a tablet having a size of about 50 g to 250 g, of about 100 g or greater, or about 40 g to about 11,000 g.

In other embodiments, the solid composition is provided in the form of a multiple-use solid, such as, a block or a plurality of pellets, and can be repeatedly used to generate aqueous rinse compositions for multiple washing cycles. In certain embodiments, the solid composition is provided as a solid having a mass of about 5 g to 10 kg. In certain embodiments, a multiple-use form of the solid composition has a mass of about 1 to 10 kg. In further embodiments, a multiple-use form of the solid composition has a mass of about 5 kg to about 8 kg. In other embodiments, a multiple-use form of the solid detergent composition has a mass of about 5 g to about 1 kg, or about 5 g and to 500 g.

### Methods of Use

The compositions can be dispensed as a solid concentrate or as a use solution. The compositions can be applied directly to an article (e.g. ware) to be cleaned, in a sink, or to water to form a use solution. The use solution can be applied to the article surface during a presoak application, immediately preceding a manual or automated wash application, or during a manual or automated wash application. Alternatively, the use solution can be applied to a surface, such as a tissue (e.g. hand washing), for manual cleaning in need of high foaming.

The solid compositions are dissolved and diluted to form a use solution. Similarly, liquid concentrates are diluted to form a use solution. Preferably they are dissolved and diluted with water. In some embodiments, the water can be heated water, the use solution can be heated, or both the water can be heated and the use solution can be heated. Preferably, the water has a temperature of at least about 35° C., more preferably at least about 40° C., still more preferably at least about 45° C., even more preferably at least about 50° C. In a preferred embodiment the water has a temperature of greater than 35° C. and less than about 100° C., more preferably from about 40° C. to about 90° C., still more preferably from about 45° C. to about 80° C., even more preferably from about 45° C. to about 75° C.

In embodiments the diluting of the composition with water can include a dilution at a ratio of about 1:50 to about 1:1000, or from about 1:50 and about 1:300 to form a use solution.

In embodiments the nature of the soil or cleaning in need of a surface or an article will determine the amount of contact time. In some embodiments a contact time with the use solution of at least a few seconds to an hour, at least about 15 seconds to an hour, or at least about 30 seconds, or at least about 60 seconds provides sufficient contact time for desired detergency (e.g. loosening, capturing or removing the soil with the foaming and detersive surfactants) of the foaming compositions.

In exemplary embodiments, the contacting step with the article or surface is at least about 15 seconds, or at least about 30 seconds, and wherein dilution ratio is from about 1:100 and about 1:3000, or from about 1:200 and about 1:3000.

The methods can further include a step of mechanical action to aid in removal of soils. The methods can further include a rinsing step to remove the foaming composition.

In embodiments the use solution has from about 100 ppm to about 5000 ppm, or from about 300 ppm to about 5000 ppm of the compositions for high foaming detergency.

### EMBODIMENTS

The present disclosure is further defined by the following numbered embodiments:

1. A detergent composition comprising: a high foaming anionic surfactant, wherein the anionic surfactant is a low-1,4 dioxane surfactant; a high foaming alcohol ethoxylate or alcohol alkoxylate surfactant having between 4-10 EO groups; one or more co-surfactants comprising a sulfosuccinate, an amine oxide or alcohol ethoxylate surfactant having between 1-3 EO groups, wherein the ratio of alcohol ethoxylate or alcohol alkoxylate surfactant having between 4-10 EO groups to the alcohol ethoxylate surfactant having between 1-3 EO groups is from about 1:1 to about 10:1, and wherein the detergent composition is a solid or liquid, high foaming and wetting detergent that is resistant to soil and mitigates 1,4 dioxane.

2. The composition of embodiment 1, wherein the co-surfactants comprise a dialkyl sulfosuccinate, preferably a dioctyl sulfosuccinate (DOSS).

3. The composition of any one of embodiments 1-2, wherein the co-surfactants comprise an amine oxide selected from the group consisting of alkyl amine oxide, lauric MEA, coco MEA and combinations thereof.

4. The composition of embodiment 3, wherein the alkyl amine oxide is a C10-C16, preferably a C12 amine oxide.

5. The composition of any one of embodiments 1-4, wherein the ratio of alcohol ethoxylate or alcohol alkoxylate surfactant having between 4-10 EO groups to the alcohol ethoxylate surfactant having between 1-3 EO groups is from about 5:1 to about 2:1, or from about 5:1 to about 4:1.

6. The composition of any one of embodiments 1-5, wherein the ratio of anionic surfactant to the amine oxide is about 2:1 to 4:1.

7. The composition of any one of embodiments 1-6, wherein the ratio of sulfosuccinate co-surfactant to a second co-surfactant, preferably the amine oxide, is from about 9:1 to about 3:7 on a weight basis, or from about 21:1 to about 1:1 on an actives basis.

8. The composition of any one of embodiments 1-7, wherein the alcohol ethoxylate or alcohol alkoxylate surfactant having between 4-10 EO groups comprises a predominantly linear C8-C18, or C9-C12 alcohol ethoxylate.

9. The composition of any one of embodiments 1-8, wherein the composition mitigates 1,4 dioxane as the solid or liquid detergent composition contains less than about 1 ppm 1,4 dioxane.

10. The composition of any one of embodiments 1-9, wherein the composition is free of alkyl ether sulfates, or free of Lauryl Ether Sulfate and Sodium Lauryl Ether Sulfate.

11. The composition of any one of embodiments 1-10, wherein the co-surfactant comprises: an alkyl amine oxide and sulfosuccinate; an alkyl amine oxide and an alcohol ethoxylate surfactant having between 1-3 EO groups; or an alkyl amine oxide, and sulfosuccinate and an alcohol ethoxylate surfactant having between 1-3 EO groups.

12. The composition of any one of embodiments 1-11, wherein the high foaming anionic surfactant comprises from about 0.5-60 wt-%, wherein the high foaming alcohol ethoxylate or alcohol alkoxylate surfactant comprises from about 0.1-25 wt-%, and the one or more co-surfactants comprises from about 0.1-20 wt-% of the composition.

13. The composition of any one of embodiments 1-12, wherein the active weight percentage of nonionic surfactant exceeds the active weight percentage of anionic surfactant.

14. A method of using a 1,4 dioxane mitigated solid or liquid detergent composition comprising: generating a use solution of the solid or liquid composition according to any one of embodiments 1-13; and contacting an article or surface in need of cleaning with the use solution.

15. The method of claim 14, wherein the detergent composition contains less than about 1 ppm 1,4 dioxane.

16. The method of any one of embodiments 14-15, wherein the article is ware.

17. The method of any one of embodiments 14-16, wherein the ware comprises pots and/or pans.

18. The method of any one of embodiments 14-17, further comprising a mechanical action step to remove soils and/or a rinsing step to remove the use solution from the article or surface.

19. The method of any one of embodiments 14-18, wherein the use solution has a temperature of greater than about 35° C.

20. The method of any one of embodiments 14-19, wherein the use solution provides from about 100 ppm to 5000 ppm of the detergent composition.

21. The method of any one of embodiments 14-20, wherein the ratio of co-surfactants is selected for a desired viscosity range to dispense the solid or liquid composition or a use solution thereof from an inline dispensing system.

22. The method of any one of embodiments 14-21, wherein the performance of the detergent is not adversely impacted by hard water (e.g. grains per gallon (gpg) measurement greater than or equal to 7.5 gpg).

### EXAMPLES

Embodiments of the present disclosure are further defined in the following non-limiting Examples. It should be understood that these Examples, while indicating certain embodiments of the disclosure, are given by way of illustration only. From the above discussion and these Examples, one skilled in the art can ascertain the essential characteristics of this disclosure, and without departing from the spirit and scope thereof, can make various changes and modifications of the embodiments of the disclosure to adapt it to various usages and conditions. Thus, various modifications of the embodiments of the disclosure, in addition to those shown and described herein, will be apparent to those skilled in the art from the foregoing description. Such modifications are also intended to fall within the scope of the appended claims.

The following ingredients are utilized in the Examples:

Aerosol OT-100—dioctyl sulfosuccinate sodium (DOSS) salt (100% active), made by Solvay.

Bioterge AS-40K/Alpha Olefin Sulfonate (40%)—an alkyl olefin sulfonate (AOS), anionic surfactant.

Barlox 12 (30%), C12 Amine Oxide—an amphoteric surfactant.

Coco Monoethanolamide—a nonionic surfactant.

ColaTrope INC—a sodium salt of nonanoic acid (45% solution of sodium isononanoate), commercially available from Colonial Chemical.

UltraDOSS 70—70% active dioctyl sulfosuccinate sodium salt, made by MFG Chemical.

Glucopon 50G—a 50% active granular C12-14 alkyl polyglucoside available from BASF.

Lauric Monoethanolamide (Monamide LMA)—a surfactant.

Lutensol TO-5—a nonionic surfactant, commercially available from BASF.

Magnesium Sulfate—an inorganic salt.

Magnesium Sulfate Heptahydrate—an inorganic salt.

Multiwet—a dialkyl sulfosuccinate surfactant (available as 70% active solution or powder), commercially available from Croda.

Nalco 7667—75% dioctyl sodium sulfosuccinate and 7% ethanol.

PEG 8000—polyethylene glycol.

Safol 23E70—a branched SLS.

Sodium Acetate—an organic sodium salt.

Silicone Antifoam 544—a silicone glycol foam control agent, commercially available from Dow Corning.

Silwet L-77—nonionic organosilicone surfactant co-polymer, commercially available from Momentive.

Sodium Alkyl Benzene Sulfonate flake—an anionic surfactant.

Sodium Lauryl Ether Sulfate (SLES)—an anionic surfactant.

Sodium Lauryl Sulfate (SLS)—an anionic surfactant.

Sodium Sulfate—an anionic surfactant.

Sodium Xylene Sulfonate—a hydrotrope.

Sokalan HP 20—an ethoxylated polyethyleneimine polymer.

Succinate—a dicarboxylic acid dianion.

Tomadol 91-2.5—an ethoxylated alcohol surfactant 2.5EO, commercially available from Evonik.

Tomadol 91-6—an ethoxylated alcohol surfactant 6EO, commercially available from Evonik.

Tomadol 91-8—an ethoxylated alcohol surfactant 8EO, commercially available from Evonik.

Other commercially available ingredients such as glutaraldehyde, glutamate, color/dye, fragrance, water, and salt.

### Example 1

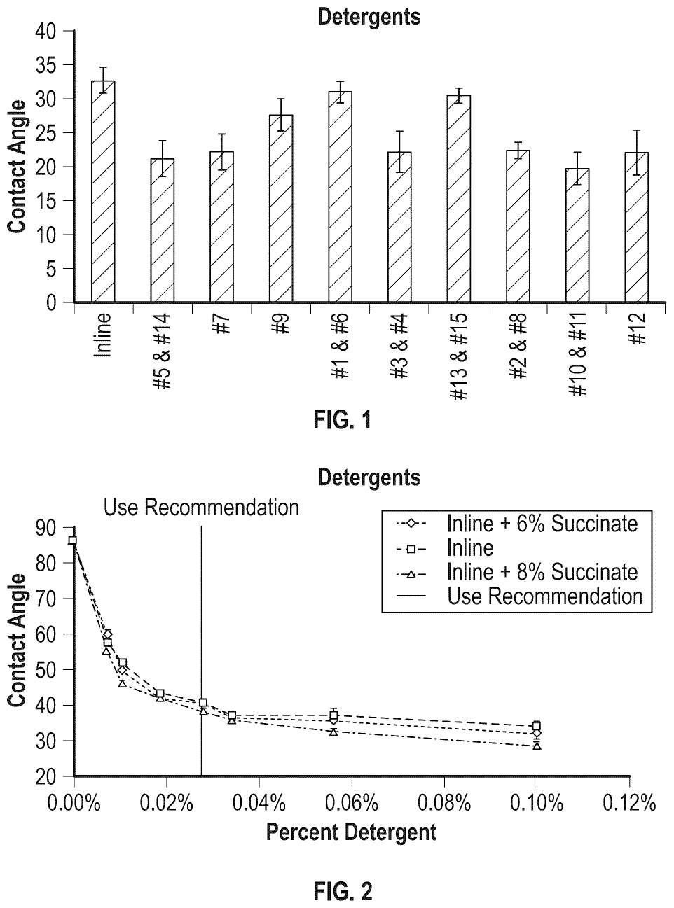

Various compositions were made as described in Table 2 below for evaluation of contact angle based on the surfactant compositions employed. 0.75 oz of the compositions of Table 2 were then diluted with 20 gallons of water. These dilutions were evaluated for their contact angle measurements, which are shown in FIG. 1. Duplicate compositions, such as #1 and #6, #2 and #8, #3 and #4, #5 and #14, #10 and #11, and #13 and #15, were evaluated and the average of the two measurements is shown in FIG. 1.

TABLE 2A

| Description | Inline | #1 | #2 | #3 | #4 | #5 | #6 | #7 | #8 |
|---|---|---|---|---|---|---|---|---|---|
| Sodium Alkyl | 45.97 | 44.14 | 44.14 | 44.14 | 44.14 | 44.14 | 44.14 | 44.14 | 44.14 |
| Benzene Sulfonate, | | | | | | | | | |
| Flake | | | | | | | | | |
| Sodium Acetate, | 6.64 | 6.38 | 6.38 | 6.38 | 6.38 | 6.38 | 6.38 | 6.38 | 6.38 |
| Anhydrous | | | | | | | | | |
| Magnesium Sulfate | 7.54 | 7.24 | 7.24 | 7.24 | 7.24 | 7.24 | 7.24 | 7.24 | 7.24 |
| Heptahydrate | | | | | | | | | |
| Glucopon 50G | 10.72 | 10.29 | 10.29 | 10.29 | 10.29 | 10.29 | 10.29 | 10.29 | 10.29 |
| PEG 8000 | 2.99 | 2.87 | 2.87 | 2.87 | 2.87 | 2.87 | 2.87 | 2.87 | 2.87 |
| Lauric | 5.35 | 5.13 | 5.13 | 5.13 | 5.13 | 5.13 | 5.13 | 5.13 | 5.13 |
| Monoethanolamide | | | | | | | | | |
| (Monamide LMA) | | | | | | | | | |
| Silicone Antifoam | 0.02 | 0.02 | 0.02 | 0.02 | 0.02 | 0.02 | 0.02 | 0.02 | 0.02 |
| 544 | | | | | | | | | |
| Coco | 4.26 | 4.09 | 4.09 | 4.09 | 4.09 | 4.09 | 4.09 | 4.09 | 4.09 |
| Monoethanolamide | | | | | | | | | |
| Sodium Lauryl | 16.04 | 15.40 | 15.40 | 15.40 | 15.40 | 15.40 | 15.40 | 15.40 | 15.40 |
| Ether Sulfate 70% | | | | | | | | | |
| ColaTrope INC | 0 | 4 | 0 | 2 | 2 | 1.33 | 4 | 0.67 | 0 |
| Aerosol OT-100 | 0 | 0 | 0 | 0 | 0 | 1.33 | 0 | 0.67 | 0 |
| Silwet L-77 | 0 | 0 | 4 | 2 | 2 | 1.33 | 0 | 2.67 | 4 |
| Additional | <2 | <2 | <2 | <2 | <2 | <2 | <2 | <2 | <2 |
| Functional | | | | | | | | | |
| Ingredients (Dye, | | | | | | | | | |
| Fragrance, | | | | | | | | | |
| Preservative) | | | | | | | | | |
| Total | 100 | 100 | 100 | 100 | 100 | 100 | 100 | 100 | 100 |

TABLE 2B

| Description | #9 | #10 | #11 | #12 | #13 | #14 | #15 |
|---|---|---|---|---|---|---|---|
| Sodium Alkyl Benzene | 44.14 | 44.14 | 44.14 | 44.14 | 44.14 | 44.14 | 44.14 |
| Sulfonate, Flake | | | | | | | |
| Sodium Acetate, Anhydrous | 6.38 | 6.38 | 6.38 | 6.38 | 6.38 | 6.38 | 6.38 |
| Magnesium Sulfate | 7.24 | 7.24 | 7.24 | 7.24 | 7.24 | 7.24 | 7.24 |
| Heptahydrate | | | | | | | |
| Alkyl Polyglycoside & Sodium | 10.29 | 10.29 | 10.29 | 10.29 | 10.29 | 10.29 | 10.29 |
| Sulfate | | | | | | | |
| PEG 8000 | 2.87 | 2.87 | 2.87 | 2.87 | 2.87 | 2.87 | 2.87 |
| Lauric Monoethanolamide | 5.13 | 5.13 | 5.13 | 5.13 | 5.13 | 5.13 | 5.13 |
| (Monamide LMA) | | | | | | | |
| Silicone Antifoam 544 | 0.02 | 0.02 | 0.02 | 0.02 | 0.02 | 0.02 | 0.02 |
| Coco Monoethanolamide | 4.09 | 4.09 | 4.09 | 4.09 | 4.09 | 4.09 | 4.09 |
| Sodium Lauryl Ether Sulfate | 15.40 | 15.40 | 15.40 | 15.40 | 15.40 | 15.40 | 15.40 |
| ColaTrope | 0.67 | 0 | 0 | 0 | 2 | 2.67 | 2 |
| Aerosol OT (DOSS) | 2.67 | 4 | 4 | 2 | 2 | 0.67 | 2 |
| Silwet L-77 | 0.67 | 0 | 0 | 2 | 0 | 0.67 | 0 |
| Additional Functional | <2 | <2 | <2 | <2 | <2 | <2 | <2 |
| Ingredients (Dye, Fragrance, | | | | | | | |
| Preservative) | | | | | | | |
| Total | 100 | 100 | 100 | 100 | 100 | 100 | 100 |

As FIG. 1 shows, the compositions that include the succinate, namely compositions #5, #7, and #9-#15, show an improved contact angle (shown as a lower contact angle) over the compositions that do not include succinate. Moreover, the compositions with just succinate, compositions #10 and #11, performed the best out of the evaluated compositions, which demonstrates the benefit of using succinate as wetting booster to have fast wetting to clean soils.

### Example 2

Based on the improvements to the compositions by including succinate in Example 1, another composition was evaluated and compared with 6% and 8% of succinate. The base composition was a Control formulation for manual detergent cleaning composition. Compositions were made according to Table 3 to assess contact angles at different concentrations of a base formulation with the addition of DOSS at varying levels (with the other components in the formulation proportionally reduced for a total wt-% of 100 wt-%). The compositions of Table 3 were then diluted to 0.02%, 0.04%, 0.06%, 0.08%, and 0.1% with water. These dilutions were evaluated for their contact angle measurements, which are shown in FIG. 2.

TABLE 3

| | Mag | Mag | Mag |
|---|---|---|---|
| | Formula | Formula | Formula |
| Description | A | B | C |
| Sodium Alkyl Benzene Sulfonate, Flake | 45.97 | 43.37 | 42.56 |
| Sodium Acetate, Anhydrous | 6.64 | 6.26 | 6.15 |
| Magnesium Sulfate Heptahydrate | 7.54 | 7.11 | 6.98 |
| Alkyl Polyglycoside & Sodium Sulfate | 10.72 | 10.11 | 9.93 |
| PEG 8000 | 2.99 | 2.82 | 2.77 |
| Lauric Monoethanolamide (Monamide | 5.35 | 5.05 | 4.95 |
| LMA) | | | |
| Silicone Antifoam 544 | 0.02 | 0.02 | 0.02 |
| Coco Monoethanolamide | 4.26 | 4.02 | 3.94 |
| Sodium Lauryl Ether Sulfate | 16.04 | 15.13 | 14.85 |
| Dialkyl Sulfosuccinate (DOSS) | 0 | 5.66 | 7.41 |
| Additional Functional Ingredients | <2 | <2 | <2 |
| (Dye, Fragrance, Preservative) | | | |
| Total | 100 | 100 | 100 |

Much like FIG. 1, the compositions of FIG. 2 with succinate showed an improvement in lowered contact angle. Mag Formula C, which contains the most succinate, outperformed the remaining composition, including the formulation without any succinate. The use recommendation rate for the detergent is shown for the Control composition representing the concentration illustrated on the x axis as close to the level recommended for the Control composition. The “use recommendation” was determined when the Apex Manual detergent was developed and optimized for great performance at the most optimized use cost.

The evaluated formulations contain 1,4 dioxane-containing surfactants that can be modified to be low or free of 1, 4 dioxane, as well as improving foam and detergency. Further evaluations of effects of replacing the SLES/LES with AOS granules and replacing PEG 8000 with amine oxide granules will be evaluated.

### Example 3

A design of experiment (DOE) study was performed to optimize the surface tension of three components Alpha Olefin Sulfonate, Multiwet (dialkyl sulfosuccinate surfactant), and C12 Amine Oxide. The DOE of surface tension results showed a synergy between the Multiwet and Amine Oxide. The DOE shows that the best ratio between Multiwet and Amine Oxide is approximately 61% to 31%, or between 9:1 to 3:7 raw material ratio, or between 21:1 to 1:1 actives ratio, with an expected surface tension of about 22.5 mN/m.

A further DOE study was performed with three surfactants: Alpha Olefin Sulphonate, Amine Oxide, and a nonionic surfactant such as Glucopon 625up, Tomadol 1-9, Tomadol 91-8, L24-7, TDA 6, Tomadol 1-5, Lutensol XL 40, Surfonic L24-3, Pluronic L64, DO097, Lutensol TO5, Lutensol AO3, and a mixture of 91-6 and 91-2.5 (in a 4:1 ratio) to target the lowest surface tension. The stock solution was made with each surfactant at 10,000 ppm (RM concentration). Then, 14 solutions, along with 3 replicates, were made with different ratios of the surfactants at a total concentration of 2,000 ppm. The surface tension of each mixture was determined with a dynamic bubble surface tension. The optimal mixing ratio of the three surfactants was evaluated. It was found that when the EO>7, there was no synergistic effect between the alcohol alkoxylate and the Alpha Olefin Sulphonate/Amine Oxide. The lowest surface tension was the solution of Alpha Olefin Sulphonate/Amine Oxide. When the EO<7, the shorter the EO, the lower the surface tension. The amount of alcohol alkoxylate to reach the lowest surface tension point also increased.

Although the low EO alcohol alkoxylates showed better surface tension, there was an opposite effect on the viscosity. The mixing order experiments showed the viscosity increased mainly due to the interaction between alcohol alkoxylate and Alpha Olefin Sulphonate. However, it also demonstrated the possibility of adjusting the viscosity with two nonionic surfactants in the mixture. Based on surface tension data, solubility, viscosity and cost, Lutensol TO5 was selected as an exemplary surfactant. Based on the above data and results, a synergy was identified for the combination of Lutensol TO5 or Multiwet dialkyl sulfosuccinate, Alpha Olefin Sulphonate and C12 Amine Oxide.

### Example 4

Exemplary compositions, based on the findings of the previous examples comprising alpha olefin sulphonate and a dioctyl sulfosuccinate source and C12 amine oxide as dual synergistic co-surfactants, are shown in Table 4. The compositions of Table 4 were compared to inline products stabilized with PEI as disclosed in U.S. Pat. No. 8,759,276, including a positively charged PEI polymer, anionic surfactant, and amine oxide.

TABLE 4

| | Mix | Mix | Mix | Mix | Mix | Mix | Mix | Mix |
|---|---|---|---|---|---|---|---|---|
| | #26 | #27 | #28 | #29 | #30 | #31 | #32 | #33 |
| Dye stock | 35 | 35 | 35 | 35 | 35 | | | |
| Blue | | | | | | | | |
| Dye stock | | | | | | 35 | 33 | 33 |
| Lemon | | | | | | | | |
| Water | 5.6 | 5.6 | 4.15 | 4.15 | 5.05 | 1.7 | 1.7 | 1.7 |
| Salt | | | 0.8 | 0.8 | 0.4 | 1.5 | 4 | 4 |
| SXS | 2.5 | 2.5 | 2.5 | 2.5 | 2.5 | 5 | 4.8 | 4.8 |
| DOSS OT-100 | 3.5 | 3.5 | | | | | | |
| Multiwet | | | 5 | 5 | 3 | 3 | | 3 |
| Nalco 7667 | | | | | | | 3 | |
| Amine Oxide | 9.7 | 9.7 | 9.7 | 9.7 | 9.7 | 9.7 | 10 | 10 |
| AOS | 39.1 | 39.1 | 39.1 | 39.1 | 39.1 | 39.7 | 40 | 40 |
| Tomadol 91-6 | 5 | | 5 | | 5 | 5 | 5 | 5 |
| Tomadol 91-8 | | | | 5 | | | | |
| Lutensol TO-5 | | 5 | | | | | | |
| Additional | <2 | <2 | <2 | <2 | <2 | <2 | <2 | <2 |
| Functional | | | | | | | | |
| Ingredients | | | | | | | | |
| (Dye, | | | | | | | | |
| Fragrance, | | | | | | | | |
| Preservative) | | | | | | | | |
| Total | 100 | 100 | 100 | 100 | 100 | 100 | 100 | 100 |
| Viscosity | 108 | 652 | 420 | 168 | 116 | 156 | 504 | 552 |

The experimental procedure for foam volume evaluated compositions in detergent use solutions for foam volume before and after the addition of soil, using a cylinder foam test. 40 mL of detergent test solution was added to a 250 mL graduated cylinder (repeated for each detergent test solution) at the depicted dose rate, water hardness and temperature as shown in the figures. All cylinders and test solutions were allowed to reach room temperature. Soil comprised of 45% shortening, 30% flour, 15% powdered egg, 10% corn oil was liquefied by placing on a hot plate at 104° F. to ensure a homogeneous liquid before adding drops to the cylinders. All cylinders were stoppered, placed in foam cylinder apparatus and securely tightened. Then cylinders were rotated at 30 rpm for 4 minutes. After 4 minutes, the initial total foam volume (volume of foam and liquid) was recorded. Then 1 drop of test soil was added using a disposable pipette to the center of the cylinder. The cylinders were rotated at 30 rpm for 2 minutes and total foam volume recorded. Then 1 more drop of test soil was added using a disposable pipette and the cylinders were rotated at 30 rpm for 2 minutes again. This cycle of rotation, measurement of total foam volume and addition of soil was repeated until total foam volume (liquid and foam volume) was at 45 mL or less. Foam volume was then calculated by subtracting 40 mL of liquid volume from each of the total foam volume measurements. 3 to 5 replicate tests were performed for each detergent test solution.

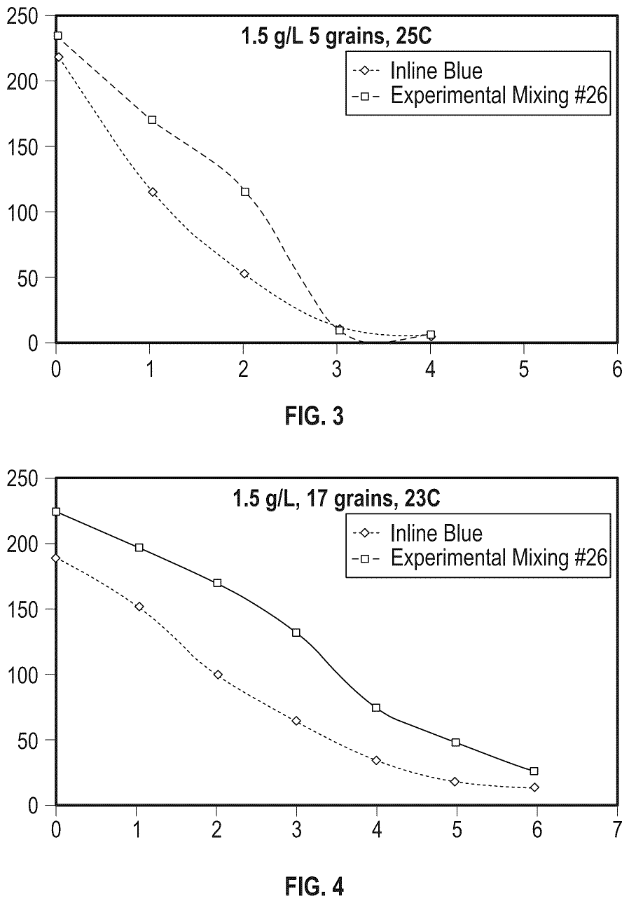

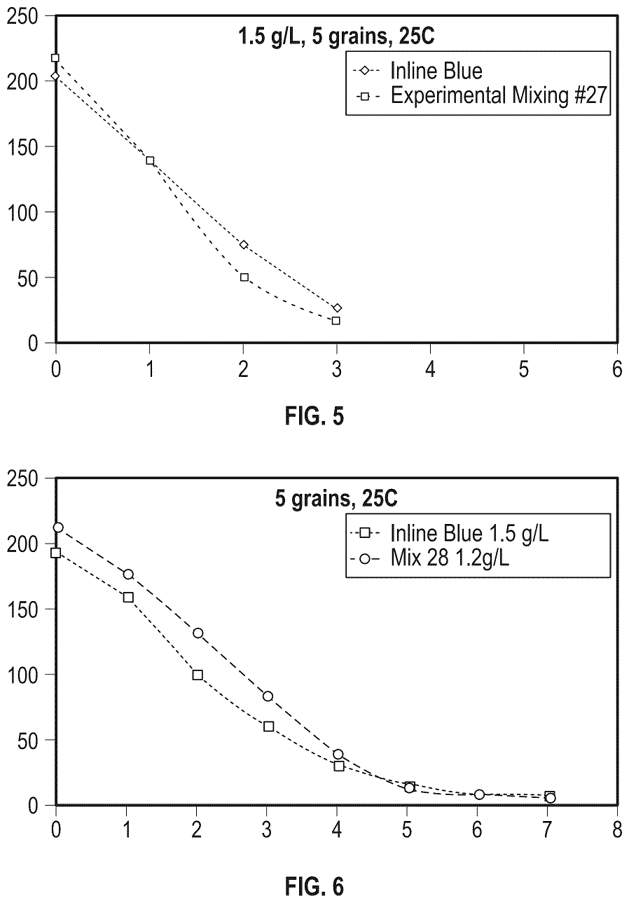

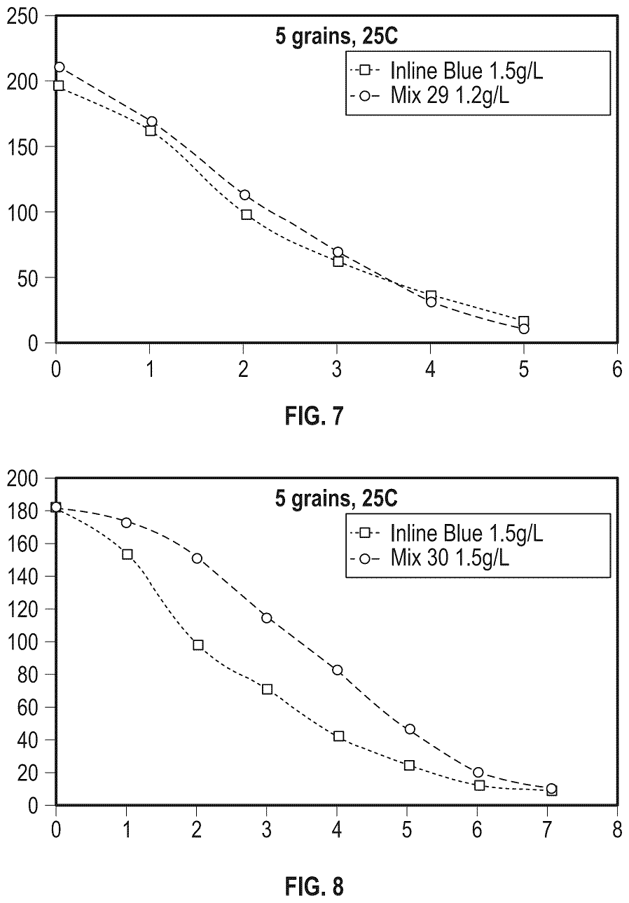

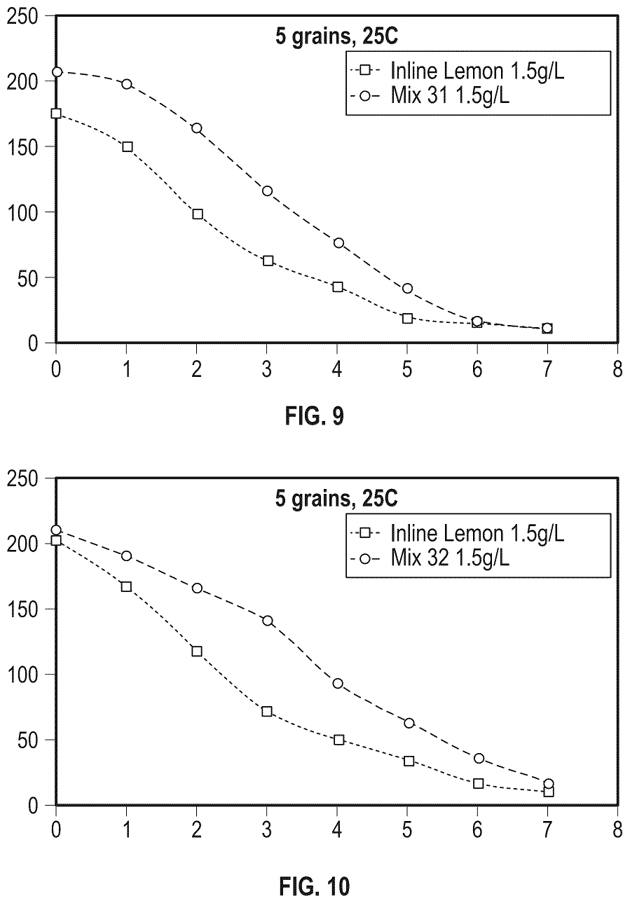

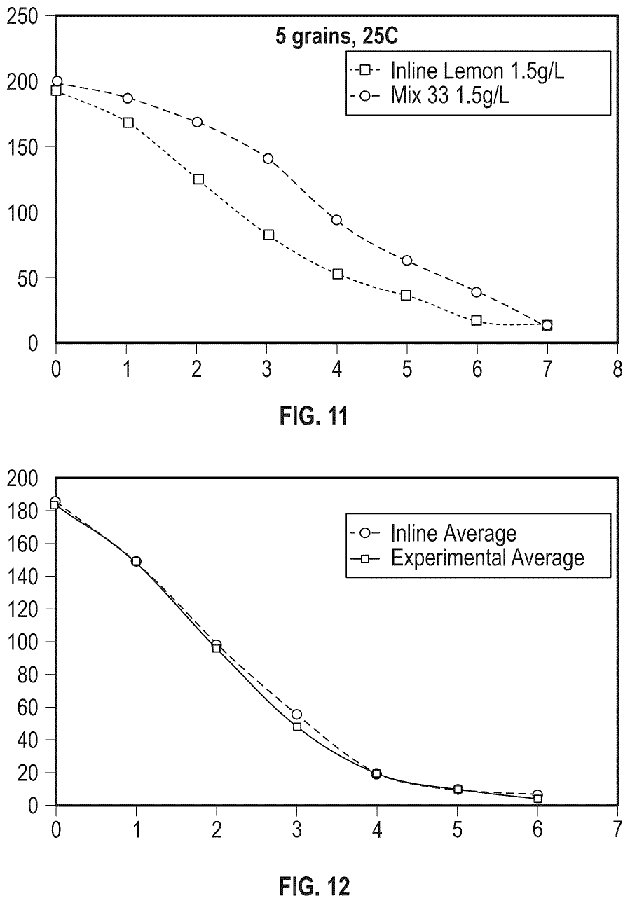

The foam volume data for the compositions of Table 4 are shown in FIGS. 3-11. In particular, 1.5 g/L of Mix #26 was compared to the same amount of an inline composition at 25° C. with 5 grain water, FIG. 3, and at 23° C. with 17 grain water, FIG. 4. In both of these figures, the Mix #26 composition outperformed the inline composition in foam volume (mL) (y-axis) measured over the number of soil drops (x-axis). FIGS. 5-11 compared the mix compositions of Table 4 against inline compositions (inline blue and inline lemon) at 25° C. and with 5 grain water. Beneficially the evaluated compositions outperform the inline compositions at both 5 grain and 17 grain water, showing an improvement due to the synergistic effects of the amine oxide and dioctyl sulfosuccinate cosurfactants in combination with alpha olefin sulfonate providing effective and stable foam under soil conditions and at varying water conditions. These results illustrate that the compositions provide a robust cleaning composition suitable for heavy duty cleaning, such as pot and pan cleaning, as the soil does not readily break down the foam, which is needed for enhanced cleaning in challenging environments.

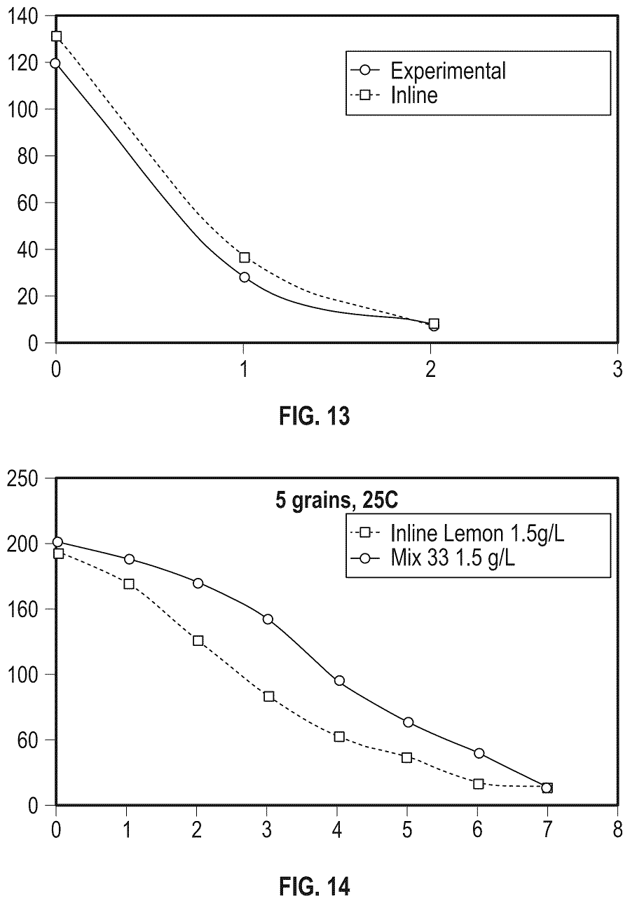

The three inline formulas have different dyes and fragrances in their formulas which can impact foam levels in the presence of soils. FIGS. 12-13 illustrate the impact of dyes and fragrances on foam levels. FIG. 12 shows the foam volume of the average of four experimental formulas, without dye and fragrance, and three inline formulas, tested at 1.5 g/L. It had almost matched foam volume profile as the inline formulas. FIG. 13 shows the foam volume of the average of three experimental formulas and three inline formulas with respective dye and fragrance, tested at 0.7 g/L. It has a lower foam volume compared with inline. In both two batches of experimental formulas, they contained the same concentration of surfactants with various Pluronic L64 concentrations in a range of 0.5% to 2.5% to adjust viscosities. Although the second batch were run at a lower concentration of 0.7 g/L, the results were consistent with 1.5 g/L.

### Example 5

Additional foam volume tested as described in Example 4 was conducted with additional exemplary compositions as shown in Table 5. Test conditions were as follows: 0.78 g/L (0.1 oz/gal) detergent test solution dose, 5 gpg water, 75 F. For each detergent test solution, 4 replicate foam tests were run simultaneously and the results were averaged.

TABLE 5

| | Formula | Formula | Formula | Formula | Formula | Formula | Formula | Formula | Formula | Formula |
|---|---|---|---|---|---|---|---|---|---|---|
| Component | 1 | 13 | 2 | 3 | 4 | 15 | 5 | 16 | 17 | 12 |
| Water | 38.795 | 39.295 | 36.725 | 34.145 | 42.145 | 42.145 | 41.445 | 42.145 | 42.145 | 46.945 |
| Sodium | 0.8 | 0.8 | 0.8 | 0.8 | 0.8 | 0.8 | 1.5 | 0.8 | 0.8 | 0.8 |
| chloride | | | | | | | | | | |
| Dye (0.15%) | 1 | 1 | 1 | 1 | 1 | 1 | 1 | 1 | 1 | 1 |
| SXS (40%) | 2 | 2 | 2 | 2 | | | | | | |
| Tomadol 91-6 | | | | | 3.5 | 2.92 | | | | 5 |
| Tomadol 91-8 | | | | | | | 3.5 | 2.92 | 2.34 | |
| Tomadol 91-2.5 | | | | | | 0.58 | | 0.58 | 1.16 | |
| ULTRADOSS | | | | | | | | | | 3 |
| 70 | | | | | | | | | | |
| SLES (60%) | 10.25 | 10.25 | 5.12 | | | | | | | |
| AOS (40%) | 27.2 | 27.2 | 34.9 | 42.6 | 36 | 36 | 36 | 36 | 36 | 28 |
| C12 amine | 19.2 | 19.2 | 19.2 | 19.2 | 16.3 | 16.3 | 16.3 | 16.3 | 16.3 | 15 |
| oxide (30%) | | | | | | | | | | |
| Sokalan HP | 0.5 | | | | | | | | | |
| 20 | | | | | | | | | | |
| % actives | 22.79 | 22.79 | 22.792 | 22.8 | 22.79 | 22.79 | 22.79 | 22.79 | 22.79 | 22.8 |
| Anionic:AO | 2.96 | 2.96 | 2.96 | 2.96 | 2.94 | 2.94 | 2.94 | 2.94 | 2.94 | 2.96 |
| Additional | <2 | <2 | <2 | <2 | <2 | <2 | <2 | <2 | <2 | <2 |
| Functional | | | | | | | | | | |
| Ingredients | | | | | | | | | | |
| (Dye, | | | | | | | | | | |
| Fragrance, | | | | | | | | | | |
| Preservative) | | | | | | | | | | |
| Total | 100 | 100 | 100 | 100 | 100 | 100 | 100 | 100 | 100 | 100 |

The results from the first round of testing are shown in Table 6 with the primary points of comparison being the inline formula (Formula 1) and the inline formula without Sokalan HP 20 (Formula 13). For the results it was desirable to have foam at/about inline, with preference to enhanced foam over inline or foam that is not less than 10% from inline.

TABLE 6

| | Formula | | | | | | |
|---|---|---|---|---|---|---|---|
| Soil added | Formula 1 | Formula 13 | Formula 2 | Formula 3 | Formula 4 | Formula 5 | Formula 12 |
| (drops) | Foam volume (mL) | | | | | | |
| 0 | 142.5 | 143.75 | 146.25 | 158.75 | 147.5 | 146.25 | 140 |
| 1 | 81.25 | 77.5 | 68.75 | 57.5 | 80 | 82.5 | 86.25 |
| 2 | 32.5 | 27.5 | 18.75 | 10 | 30 | 40 | 36.25 |
| 3 | 9 | 10 | 6 | 3 | 6 | 10 | 10 |

The results are further summarized as follows:

Formula 2: Starting with Formula 1, replaced ½ of SLES with AOS on an equal actives basis. Increased initial foam, but then decreased foam after soil added which is not desired.

Formula 3: Starting with Formula 1, replaced all SLES with AOS on an equal actives basis. Increased initial foam, but then decreased foam after soil added which is not desired.

Formula 4: Starting with Formula 1, replaced 2.64% AOS actives and 0.87% C12 amine oxide actives with 3.5% 91-6, which is 100% actives. Foam performance was comparable to inline formula.

Formula 5: Starting with Formula 1, replaced 2.64% AOS actives and 0.87% C12 amine oxide actives with 3.5% 91-8, which is 100% actives. Foam performance was comparable to inline formula.

Formula 12: Starting with Formula 1, replaced 3.75% AOS actives and 1.25% C12 amine oxide actives with 5% 91-6, which is 100% actives. Then, replaced an additional 3% AOS actives with 3% DOSS actives using ULTRADOSS 70, which is 70% active DOSS. Foam performance was comparable to inline formula.

The results from a second round of testing are shown in Table 7 with the primary point of comparison being the inline formula (Formula 1). For the results it was desirable to have foam at/about inline, with preference to enhanced foam over inline or foam that is not less than 10% from inline.

TABLE 7

| Formula | | | | |
|---|---|---|---|---|
| Soil | Formula | Formula | Formula | Formula |
| added | 1 | 3 | 4 | 15 |
| (drops) | Foam volume (mL) | | | |
| 0 | 142.5 | 166.25 | 150 | 145 |
| 1 | 86.25 | 73.25 | 85 | 87.5 |
| 2 | 43.75 | 23.75 | 31.25 | 47.5 |
| 3 | 13.75 | 11.25 | 9.5 | 16.25 |

The results are further summarized as follows:

Formula 15: Starting with Formula 3, replaced 2.64% AOS actives and 0.87% C12 amine oxide actives with 3.5% 5:1 91-6:91-2.5 blend, which is 100% actives. Foam performance was comparable to inline formula and slightly improved over “No SLES, 3.5% 91-6 formula”.

The results from a third round of testing are shown in Table 8 with the primary point of comparison being the inline formula (Formula 1). For the results it was desirable to have foam at/about inline, with preference to enhanced foam over inline or foam that is not less than 10% from inline.

TABLE 8

| Formula | Formula | Formula | Formula | Formula |
|---|---|---|---|---|
| Soil added | 1 | 5 | 16 | 17 |
| (drops) | Foam volume (mL) | | | |
| 0 | 147.5 | 146.25 | 145 | 143.75 |
| 1 | 88.75 | 87.5 | 85 | 81.25 |
| 2 | 47.5 | 43.75 | 37.5 | 42.5 |
| 3 | 16.25 | 10 | 11.25 | 13.75 |

The results are further summarized as follows:

Formula 16: Starting with Formula 3, replaced 2.64% AOS actives and 0.87% C12 amine oxide actives with 3.5% 5:1 91-8:91-2.5 blend, which is 100% actives. Foam performance was approximately the same (slightly less performance) than inline.

Formula 17: Starting with Formula 3, replaced 2.64% AOS actives and 0.87% C12 amine oxide actives with 3.5% 2:1 91-8:91-2.5 blend, which is 100% actives. Foam performance was comparable to inline.

The testing outlined in this example shows that removal of SLES from the formulation and replacing it with AOS on an equal actives basis increases initial foam volume. Although this is beneficial, this is not sufficient as the foam volume decreased after soil was added. It was demonstrated that replacing some of the 3:1 AOS: amine oxide blend in Formula 3 at equal actives with Tomadol 91-6 or Tomadol 91-8 resulted in foam performance comparable to that of the inline formula. Similarly use of a 5:1 or 3:1 blend of Tomadol 91-6: Tomadol 91-2.5, or with a 5:1 or 2:1 blend of Tomadol 91-8: Tomadol 91-2.5 resulted in foam performance desirably comparable to that of the inline formula. Still further, replacing both (a) some of the 3:1 AOS: amine oxide blend in Formula 3 at equal actives with Tomadol 91-6 and (b) some of the AOS at equal actives with DOSS results in foam performance comparable to that of the inline formula.

### Example 6

Compositions were evaluated for detergency and soil removal as desired for cleaning compositions, namely pot and pan formulas. The evaluated compositions are shown in Table 9. A detergent use solution for detergency and soil removal, using the coconut oil detergency testing was evaluated with the following experimental parameters:

Detergent dose: 0.78 g/L (0.1 oz/gal)

Test conditions: 5 gpg water hardness, 29 C (84 F), 30 min soak.

Soil: 95% coconut oil/5% stearic acid as the soil.

The procedure included use of clean stainless-steel panels that were weighed to record the initial clean mass of each panel. Then the coconut oil soil was prepared. Then using a new foam brush the same size as the panel, 0.19-0.21 g of soil was brushed evenly over the panel's surface, except for 0.5 in at the top of the panel. The soil was allowed to cool overnight. Then each panel was reweighed. 3000 g of 5 gpg water was added to a 4 liter beaker, heated to the target temperature (29 C), and maintained at this temperature using a hot plate and a thermometer. Detergent was added, and the solution was stirred at 250 RPM using a 2.5″ stir bar. Then using clamps to secure the panels (ensuring the clamp is not touching the oil on either panel) the panels were pressed against the wall of the beaker. The soil was fully submerged under the water (with clamps out of the water) to prevent inconsistent water flow over the panels. Once the panels were submerged, the timer was set for desired test duration and thereafter the panels were removed from water. The panels were dried on a drying rack overnight and then reweighed.

TABLE 9

| | Formula | Formula | Formula | Formula | Formula | Formula | Formula | Formula | Formula |
|---|---|---|---|---|---|---|---|---|---|
| Component | 1 | 3 | 4 | 15 | 22 | 5 | 16 | 17 | 12 |
| Water | 35-40 | 30-35 | 40-45 | 40-45 | 35-40 | 40-45 | 40-45 | 40-45 | 42-47 |
| Sodium | 0.5-2 | 0.5-2 | 0.5-2 | 0.5-2 | 0.5-2 | 0.5-2 | 0.5-2 | 0.5-2 | 0.5-2 |
| chloride | | | | | | | | | |
| Dye | 0.1-1 | 0.1-1 | 0.1-1 | 0.1-1 | 0.1-1 | 0.1-1 | 0.1-1 | 0.1-1 | 0.1-1 |
| SXS | 1-2 | 1-2 | | | | | | | |
| Tomadol | | | 2-5 | 2-5 | 2-5 | | | | 2-5 |
| 91-6 | | | | | | | | | |
| Tomadol | | | | | | 2-5 | 2-5 | 2-5 | |
| 91-8 | | | | | | | | | |
| Tomadol | | | | 0.5-2 | 0.5-2 | | 0.5-2 | 0.5-2 | |
| 91-2.5 | | | | | | | | | |
| ULTRADOSS | | | | | | | | | 2-5 |
| 70 | | | | | | | | | |
| SLES | 10-12 | | | | | | | | |
| AOS | 25-30 | 40-45 | 35-40 | 35-40 | 35-40 | 35-40 | 35-40 | 35-40 | 25-30 |
| C12 amine | 15-20 | 15-20 | 15-20 | 15-20 | 15-20 | 15-20 | 15-20 | 15-20 | 15-20 |
| oxide | | | | | | | | | |
| Sokalan HP | <1 | | | | | | | | |
| 20 | | | | | | | | | |
| Glutaraldehyde | <0.1 | <0.1 | <0.1 | <0.1 | <0.1 | <0.1 | <0.1 | <0.1 | <0.1 |
| Fragrance | <0.5 | <0.5 | <0.5 | <0.5 | <0.5 | <0.5 | <0.5 | <0.5 | <0.5 |
| % actives | 22.79 | 22.8 | 22.79 | 22.79 | 22.79 | 22.79 | 22.79 | 22.79 | 22.8 |
| Anionic:AO | 2.96 | 2.96 | 2.94 | 2.94 | 2.94 | 2.94 | 2.94 | 2.94 | 2.96 |

The results are summarized in Table 10. They show that use of co-surfactants is essential for detergency.

TABLE 10
Test Conditions
29 C., 0.1 oz/gal detergent, 5 gpg, 30 min. soak

| Formula | Formula 1 | | Formula 3 | |
|---|---|---|---|---|
| % Removal | 74% | 72% | 54% | 51% |

The results show that removing SLES and replacing it with AOS on an equal actives basis
reduces detergency, therefore demonstrating the benefit of co-surfactants in the
formulations for providing enhanced detergency as replacement of SLES with AOS alone
does not meet inline performance.

| Formula | Formula 4 | | Formula 5 | |
|---|---|---|---|---|
| % Removal | 67% | 79% | 72% | 67% |

The results show that replacing some of the 3:1 AOS:amine oxide blend in Formula 3 at
equal actives with Tomadol 91-6 or Tomadol 91-8 results in detergency comparable to that
of the inline formula.

| Formula | Formula 15 | | Formula 16 | |
|---|---|---|---|---|
| % Removal | 68% | 71% | 72% | 70% |

The results show that replacing some of the 3:1 AOS:amine oxide blend in Formula 3 at
equal actives with a 5:1 blend of Tomadol 91-6:Tomadol 91-2.5 results in detergency
comparable to that of the inline formula (Formula 1).

| Formula | Formula 22 | | Formula 17 | |
|---|---|---|---|---|
| % Removal | 65% | 80% | 71% | 74% |

The results show that replacing some of the 3:1 AOS:amine oxide blend in Formula 3 at
equal actives with a 3:1 blend of Tomadol 91-6:Tomadol 91-2.5, or with a 2:1 blend of
Tomadol 91-8:Tomadol 91-2.5, results in detergency comparable to that of the inline
formula (Formula 1).

| Formula | Formula 12 | |
|---|---|---|
| % Removal | 89% | 83% |

The results show that replacing both (a) some of the 3:1 AOS:amine oxide blend in Formula
3 at equal actives with Tomadol 91-6 and (b) some of the AOS at equal actives with DOSS
results in detergency superior to that of the inline formula (Formula 1).

### Example 7

Viscosities of various formulations were also measured at 20° C. using a Brookfield DV2T viscometer (Model DX2TLVKJ0) equipped with a small sample adapter (SC4-13R(P)) using Spindle 18, at 5 RPM for viscosities <600 cP and at 2 RPM for viscosities >600 cP. The various blends of surfactants shown in previous examples to have desirable foam and detergency produce very different viscosities, and it is desired to maintain a viscosity range that does not require modification of dispensing equipment in existing dispensers.

The compositions in Tables 11-12 were evaluated for viscosity (cP).

TABLE 11

| Component | Formula 1 | Formula 4 | Formula 15 | Formula 18 |
|---|---|---|---|---|
| Water | 35-40 | 40-45 | 40-45 | 40-45 |
| Sodium | <1 | <1 | <1 | <1 |
| chloride | | | | |
| SXS | 2 | | | 2 |
| Tomadol 91- | | 2-5 | 2-5 | 2-5 |
| 6 | | | | |
| Tomadol 91 | | | 0.5-2 | 0.5-2 |
| 2.5 | | | | |
| SLES | 10-12 | 0 | 0 | 0 |
| AOS | 25-30 | 35-40 | 35-40 | 35-40 |
| C12 amine | 15-20 | 15-20 | 15-20 | 15-20 |
| oxide | | | | |
| Sokalan HP | 0.5-2 | | | |
| 20 | | | | |
| Additional | <2 | <2 | <2 | <2 |
| Functional | | | | |
| Ingredients | | | | |
| (Dye, | | | | |
| Fragrance, | | | | |
| Preservative) | | | | |
| % actives | 22.79 | 22.79 | 22.79 | 22.79 |
| Total | 100 | 100 | 100 | 100 |
| Anionic:AO | 2.96 | 2.94 | 2.94 | 2.94 |
| Viscosity | 363 | 417 | 837 | 209 |
| (cP) | | | | |

TABLE 12

| Component | Formula 1 | Formula 5 | Formula 16 | Formula 17 | Formula 19 |
|---|---|---|---|---|---|
| Water | 35-40 | 40-45 | 40-45 | 40-45 | 40-45 |
| Sodium chloride | <1 | <1 | <1 | <1 | <1 |
| SXS | 2 | | | | 2 |
| Tomadol 91-8 | | 2-5 | 2-5 | 2-5 | 2-5 |
| Tomadol 91-2.5 | | | 0.5-2 | 0.5-2 | 0.5-2 |
| SLES | 10-12 | 0 | 0 | 0 | 0 |
| AOS | 25-30 | 35-40 | 35-40 | 35-40 | 35-40 |
| C12 amine oxide | 15-20 | 15-20 | 15-20 | 15-20 | 15-20 |
| Sokalan HP 20 | 0.5-2 | | | | |
| Additional Functional | <2 | <2 | <2 | <2 | <2 |
| Ingredients (Dye, Fragrance, | | | | | |
| Preservative) | | | | | |
| % actives | 22.79 | 22.79 | 22.79 | 22.79 | 22.79 |
| Total | 100 | 100 | 100 | 100 | Total |
| Anionic:AO | 2.96 | 2.94 | 2.94 | 2.94 | 2.94 |
| Viscosity (cP) | 363 | 111 | 229 | 609 | 154 |

The results show that the exemplary formulations can be adjusted to desired viscosity ranges, with a goal of between about 50-200% of inline (Formula 1) viscosity. In some embodiments a desired viscosity is for example between about 200-600 cP or between about 250-600 cP, where a majority of inline products are dispensed. In embodiments addition of SXS or a similar hydrotrope can aid viscosity adjustments as needed with the surfactant compositions.

The data also shows that the addition of ethoxylated alcohol with 1-3 EO (e.g., Tomadol 91-2.5) to an SLES-free composition that contains an ethoxylated alcohol with 4-10 EO can increase viscosity, and the sensitivity of viscosity to wt % NaCl, back to the levels characteristic of the inline formula. This is beneficial as the inclusion of the Tomadol 91-2.5 does not negatively impact foam and detergency performance.

### Example 8

Further analysis of the co-surfactant packages combining AOS (anionic surfactant), Amine Oxide (co-surfactant), and non-ionic surfactant (alcohol ethoxylates) was conducted. 2000 ppm total surface tension of 3-component surfactant composition was evaluated in their raw material forms. The 3-component raw materials added up to 1 (weight % of each component is each fractional weight times 100). The summary of the results are shown in Table 13. The numbers on each row indicate the optimal weight fractions of each component predicted for the lowest surface tension.

TABLE 13

| Non-ionic(s) | Nonionic Surfactant, | AOS, wt. | AO, wt. | Predicted Surface | Measured surface |
|---|---|---|---|---|---|
| and DOSS | wt. fraction | fraction | fraction | Tension | tension |
| Glucopon 625 UP | 0 | 0.5 | 0.5 | 23.6 | 24.2 |
| Tomadol 1-9 | 0 | 0.5 | 0.5 | 23.6 | 24.2 |
| Tomadol 91-8 | 0 | 0.5 | 0.5 | 23.7 | 24.2 |
| L24-7 | 0.06 | 0.42 | 0.52 | 23.9 | 25 |
| TDA 6 | 0.14 | 0.39 | 0.47 | 23.1 | 23.8 |
| Tomadol 1-5 | 0.16 | 0.39 | 0.45 | 23.0 | 23.7 |
| XL-40 | 0.17 | 0.39 | 0.44 | 22.4 | 23.3 |
| L24-3 | 0.17 | 0.44 | 0.38 | 22.1 | 23.3 |
| Pluronic L64 | 0.44 | 0.25 | 0.31 | 22.0 | 24.1 |
| LD097 | 0.54 | 0.22 | 0.24 | 19.5 | 22.9 |
| Multiwet 70 | 0.61 | 0 | 0.39 | 22.5 | 23.3 |
| TO5 | 0.16 | 0.42 | 0.42 | 22.2 | 23.2 |
| AO3 | 0.18 | 0.43 | 0.39 | 21.5 | 22.7 |

The nonionic surfactant significantly impacts viscoelasticity of the composition with co-surfactants, as further shown in Tables 14A-14E. Use of Alcohol (EO)₄₋₁₀ result in manageable viscosity, while use of Alcohol (EO)₁₋₃ result in much higher viscosity, in some cases a gel.

### Tables 14A-14E

TABLE 14A

| | |
|---|---|
| water | 39.79 |
| AOS | 24.36 |
| AO | 22.06 |
| Lutensol AO3 | 10.12 |
| High viscosity | >7400 |
| gel CP | |

TABLE 14B

| | |
|---|---|
| water | 39.79 |
| AOS | 24.36 |
| AO | 22.06 |
| Lutensol TO 5 | 10.12 |
| Viscosity (cP) | 1528 |

TABLE 14C

| | |
|---|---|
| water | 39.79 |
| AOS | 24.36 |
| AO | 22.06 |
| TDA6 | 7.93 |
| Viscosity (cP) | 900 |

TABLE 14D

| | |
|---|---|
| water | 39.79 |
| AOS | 24.36 |
| AO | 22.06 |
| Pluronic L62 | 7.93 |
| no viscosity build up 4cp | |

TABLE 14E

| | |
|---|---|
| water | 39.79 |
| AOS | 24.36 |
| AO | 22.06 |
| Tergitol 15- | 7.93 |
| S-3 gel | |

### Example 9

Combining nonionic alcohol ethoxylates (EO) 1-10 with an amphoteric amine oxide co-surfactant, and DOSS an anionic co-surfactant provides significant compositional flexibility for foam volume, detergency, and viscosity. These surfactants can increase viscosity of a liquid pot and pan composition, and an alcohol (EO) 1-3 is minimally affected by pH and water hardness, although the amine oxide and DOSS are more significantly affected by pH and water hardness. As shown in Table 15 is a design analysis was extended to raw materials AOS, AO and nonionic surfactants (4:1 Tomadol 91-6 to Tomadol 91-2.5), with an optimal point for 2000 ppm surface tension.

TABLE 15

| | RM wt. % | RM active |
|---|---|---|
| RM | (no water added) | wt. % |
| 4:1 Tomadol 91-6 to | 18 | 18 |
| Tomadol 91-2.5 | | |
| AOS | 41 | 16.4 |
| AO | 41 | 12.3 |

Notably the Tomadol alcohol ethoxylates are all 100% active, whereas the AOS raw material is 40% active and AO raw material is 30% active. The summary of wt-% of raw materials in the preferred formulations is divergent from conventional high foaming compositions, such as for pot-and-pan detergent compositions where the majority surfactant is anionic (minority nonionic). In embodiments the compositions described herein are majority nonionic surfactant (minority anionic).

### Example 10

Additional foam volume testing was conducted as described in Example 4 comparing composition with 4:1 Tomadol 91-6/Tomadol 91-2.5 (Mix 39) with a composition with Tomadol 91-6 (Mix 33). The composition included AOS as foaming anionic, Tomadol 91-6 as foaming nonionic, and (amine oxide+DOSS) as co-surfactants. The first composition has active AOS 16 wt. %; active Tomadol 91-6 5 wt. %) as shown in Table 16.

TABLE 16
Mix #33

| Dye stock | |
|---|---|
| Lemon | 33 |
| Salt | 4 |
| SXS | 4.8 |
| Multiwet 70 | 3 |
| AO | 10 |
| AOS | 40 |
| 91-6 | 5 |
| Glutaraldehyde | 0.02 |
| Fragrance | 0.225 |

The results shown in FIG. 14 show that the composition of Table 16 provide enhanced foam volume compared to Inline Control even as soil increases to challenge the foam.

The second composition has active AOS 8.48 wt. %; 10.6 wt-% active 4:1 Tomadol 91-6/Tomadol 91-2.5 as shown in Table 17.

TABLE 17
Mix #39

| Dye stock | |
|---|---|
| Lemon | 35 |
| Water | 1 |
| Salt | 3 |
| SXS | 4.8 |
| Multiwet | 3 |
| AO | 21.2 |
| AOS | 21.2 |
| 91-6/91-2.5 4:1 | 10.6 |
| Glutaraldehyde | 0.02 |
| Fragrance | 0.225 |

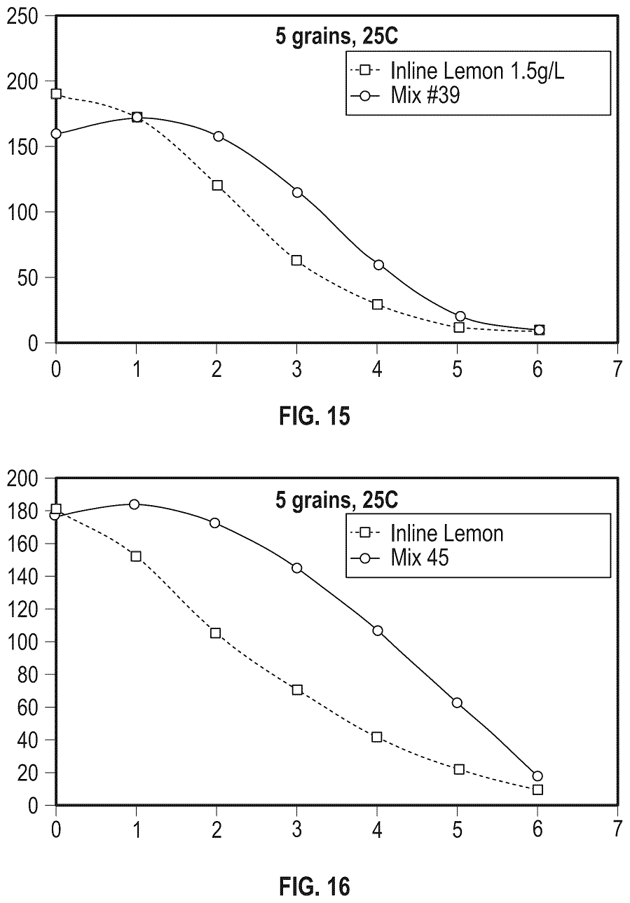

The results shown in FIG. 15 show that the composition of Table 17 provide enhanced foam volume compared to Inline Control even as soil increases to challenge the foam.

### Example 11

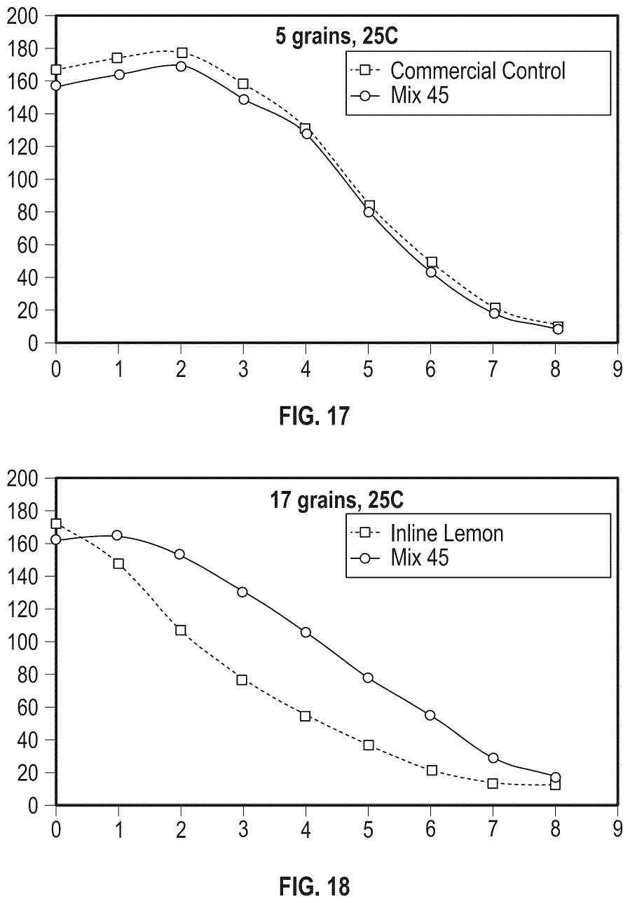

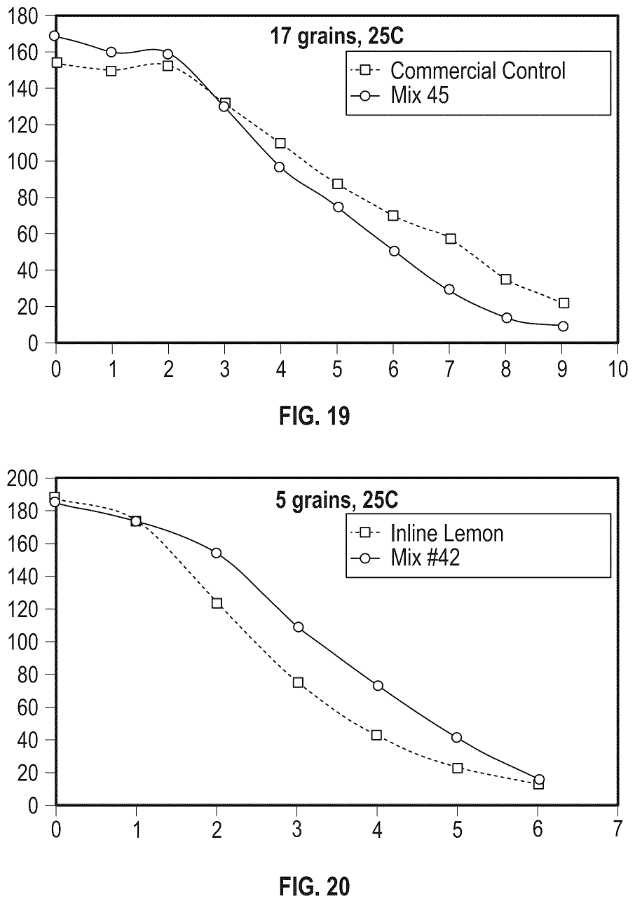

Additional foam volume data was obtained for the compositions of Table 18 and Table 19 in FIGS. 15-19 and FIG. 20, respectively, according to the procedures described in Example 4.

TABLE 18
Mix45

| | |
|---|---|
| Dye water | 35 |
| Water | 1.5 |
| NaCl | 2.5 |
| SXS (40%) | 3 |
| DOSS | 0.75 |
| Barlox 12 | 10 |
| AOS | 40 |
| 91-6 | 7 |
| Additional Functional | <2 |
| Ingredients (Dye, Fragrance, | |
| Preservative) | |
| Total | 100 |
| Viscosity | 634 |

The results show that Composition (Mix 45) with alcohol ethoxylate (in this case 7% Tomadol 91-6) exhibits desirable extra soil-resistant foam characteristics. This evaluated composition has more active AOS than active Tomadol 91-6, which is less desirable with respect to the Krafft temperature of the surfactant and results in poor cleaning performance compared to inline formulation with SLES, despite outperforming the commercial control. As a result a further composition shown in Table 19 was evaluated.

TABLE 19
Mix 42

| | |
|---|---|
| Dye water | 35 |
| Water | |
| NaCl | 4 |
| SXS (40%) | 3 |
| DOSS | 0.75 |
| Barlox 12 | 11 |
| AOS | 41.5 |
| 91-6 | 4 |
| Additional Functional Ingredients | <2 |
| (Dye, Fragrance, Preservative) | |
| Total | 100 |
| Viscosity | 1548 |

The results for composition (Mix 42) combine dual co-surfactant (AO and DOSS; no Tomadol 91-2.5) and provide cleaning performance equivalent to the inline composition with improved foam over the inline composition.

### Example 12

Additional foam volume testing as described in Example 5 was conducted with additional exemplary compositions shown in Table 20. For each detergent, 4 replicate foam tests were run simultaneously and the results were averaged. One important difference from the testing described in Example 5 is that two drops of soil were added after each measurement instead of one drop.

TABLE 20

| | | | | Formula 32 | Formula 33 | |
|---|---|---|---|---|---|---|
| | | | | SLES and | SLES-free, | |
| | | | | AOS | AOS | |
| | | | | replaced | replaced | |
| | | | | with | with | |
| | Commercial | Formula 30 | Formula 31 | branched | branched | Formula 34 |
| Component | Control | SLES-free | SLES-free | SLS | SLS | SLES-free |
| Soft Water | 65-85 | 74.1235 | 71.6035 | 77.3235 | 82.1735 | 71.4335 |
| SXS (40%) | 0-2 | 0 | 0 | 2 | 0 | 6 |
| Sodium | 2-6 | 3.5 | 4.5 | 2 | 2 | 0 |
| Chloride | | | | | | |
| SLES, LD | 4-5 | 0 | 0 | 0 | 0 | 0 |
| (60%) | | | | | | |
| AOS (40%) | 10-17 | 15.28 | 16.98 | 0 | 0 | 15.27 |
| Safol 23E70 | 0-11 | 0 | 0 | 10.04 | 8.73 | 0 |
| Hexylene | 0-1 | 0 | 0 | 0.5 | 0 | 0 |
| glycol | | | | | | |
| Tomadol 91-6 | 0-2 | 1.75 | 0 | 0 | 1.75 | 0 |
| Ecosurf EH-9 | 0-1 | 0 | 1 | 0 | 0 | 1.95 |
| (90%) | | | | | | |
| C12 Amine | 5-8 | 5.09 | 5.66 | 7.88 | 5.09 | 5.09 |
| Oxide (30%) | | | | | | |
| Additional | <2 | <2 | <2 | <2 | <2 | <2 |
| Functional | | | | | | |
| Ingredients | | | | | | |
| (Dye, | | | | | | |
| Fragrance, | | | | | | |
| Preservative) | | | | | | |
| Total | 100 | 100 | 100 | 100 | 100 | 100 |

The results from the first round of testing are shown in Table 21 with the primary point of comparison being the Commercial Control. Test conditions were as follows: 1.8723 g/L (0.25 oz/gal) detergent dose, 5 gpg water, 75 F. For the results it was desirable to have foam at/about the Commercial Control, with preference to enhanced foam over the Commercial Control or foam that is not less than 10% from the Commercial Control.

TABLE 21

| | Commercial | Formula | Formula | Formula | Formula |
|---|---|---|---|---|---|
| Formula | Control | 30 | 31 | 32 | 33 |
| Soil (drops) | Foam Volume (mL) | | | | |
| 0 | 145 | 137 | 147 | 161 | 137.5 |
| 2 | 64 | 80 | 64 | 66.5 | 79.5 |
| 4 | 14 | 31.5 | 17.5 | 13.5 | 31.5 |
| 6 | 3.5 | 7.5 | 6 | 5 | 5.5 |
| 8 | — | 2.5 | 1 | 0 | 2.5 |
| Total Foam (mL) | 226.5 | 258.5 | 235.5 | 246 | 256.5 |

The results from the second round of testing are shown in Table 22 with the primary point of comparison being the Commercial Control. Test conditions were as follows: 2.6212 g/L (0.35 oz/gal) detergent dose, 5 gpg water, 75 F. For the results it was desirable to have foam at/about the Commercial Control, with preference to enhanced foam over the Commercial Control or foam that is not less than 10% from the Commercial Control.

TABLE 22

| | Formula | | | | | |
|---|---|---|---|---|---|---|
| | Commercial | Formula | Formula | Formula | Formula | Formula |
| Soil | Control | 30 | 31 | 32 | 33 | 34 |
| (drops) | Foam Volume (mL) | | | | | |
| 0 | 144.5 | 153.5 | 157 | 163.5 | 151.5 | 157.5 |
| 2 | 99.5 | 115 | 101.5 | 110.5 | 123.5 | 105.5 |
| 4 | 65.5 | 70 | 62.5 | 67.5 | 76 | 80 |
| 6 | 23.5 | 23.5 | 21 | 18.5 | 23.5 | 31 |
| 8 | 8.5 | 8.5 | 7.5 | 11.5 | 8.5 | 13 |
| 10 | 6.5 | 3 | 1.5 | 5 | 1 | 3.5 |
| 12 | 2 | — | — | 1 | — | — |
| Total | 350 | 373.5 | 351 | 387.5 | 384 | 400.5 |
| Foam | | | | | | |
| (mL) | | | | | | |

Three of the SLES-free Formulas (Formulas 30, 32, and 33) outperformed the Commercial Control whereas Formula 31 performed comparably to the Commercial Control. Comparing the Commercial Control to Formula 32, replacing AOS and SLES with Safol 23E70 (branched SLS) increased total foam. Comparing the Commercial Control to Formula 30, replacing SLES with AOS and Tomadol 91-6 increased total foam. Comparing Formula 30 and Formula 33, replacing 1.75% Tomadol 91-6 with 1.0% Ecosurf EH-9 (90%) and 1.7% AOS (40%) did not affect total foam. Formula 34 (SLES-free, 1.95% Ecosurf EH-9 (90%)) outperformed all other formulas, but it was difficult to build the viscosity of this formula to a desirable range (250-600 cP).

It is to be understood that while the invention has been described in conjunction with the detailed description thereof, the foregoing description is intended to illustrate, and not limit the scope of the invention, which is defined by the scope of the appended claims. Other embodiments, advantages, and modifications are within the scope of the following claims. Any reference to accompanying drawings which form a part hereof, are shown, by way of illustration only. It is understood that other embodiments may be utilized and structural changes may be made without departing from the scope of the present disclosure. All publications discussed and/or referenced herein are incorporated herein in their entirety.

The features disclosed in the foregoing description, or the following claims, or the accompanying drawings, expressed in their specific forms or in terms of a means for performing the disclosed function, or a method or process for attaining the disclosed result, as appropriate, may, separately, or in any combination of such features, be utilized for realizing the invention in diverse forms thereof

What is claimed is:

1. A detergent composition comprising:
a high foaming anionic surfactant, wherein the anionic surfactant is a low-1,4 dioxane surfactant;
a high foaming alcohol ethoxylate or alcohol alkoxylate surfactant having between 4-10 EO groups;
one or more co-surfactants comprising a sulfosuccinate, an amine oxide or alcohol ethoxylate surfactant having between 1-3 EO groups,
wherein the ratio of alcohol ethoxylate or alcohol alkoxylate surfactant having between 4-10 EO groups to the alcohol ethoxylate surfactant having between 1-3 EO groups is from about 1:1 to about 10:1, and
wherein the detergent composition is a solid or liquid, high foaming and wetting detergent that is resistant to soil and mitigates 1,4 dioxane.

2. The composition of claim 1, wherein the co-surfactants comprise a dialkyl sulfosuccinate, preferably a dioctyl sulfosuccinate (DOSS).

3. The composition of claim 1, wherein the co-surfactants comprise an amine oxide selected from the group consisting of alkyl amine oxide, lauric MEA, coco MEA, and combinations thereof.

4. The composition of claim 3, wherein the alkyl amine oxide is a C10-C16 amine oxide.

5. The composition of claim 1, wherein the ratio of alcohol ethoxylate or alcohol alkoxylate surfactant having between 4-10 EO groups to the alcohol ethoxylate surfactant having between 1-3 EO groups is from about 5:1 to about 2:1.

6. The composition of claim 1, wherein the ratio of anionic surfactant to the amine oxide is about 2:1 to 4:1.

7. The composition of claim 1, wherein the ratio of sulfosuccinate co-surfactant to a second co-surfactant is from about 9:1 to about 3:7 on a weight basis, or from about 21:1 to about 1:1 on an actives basis.

8. The composition of claim 1, wherein the alcohol ethoxylate surfactant having between 4-10 EO groups comprises a predominantly linear C8-C18, or C9-C12 alcohol ethoxylate.

9. The composition of claim 1, wherein the composition mitigates 1,4 dioxane as the solid or liquid detergent composition contains less than about 1 ppm of 1,4 dioxane.

10. The composition of claim 1, wherein the composition is free of alkyl ether sulfates, or free of Lauryl Ether Sulfate and Sodium Lauryl Ether Sulfate.

11. The composition of claim 1, wherein the co-surfactant comprises: an alkyl amine oxide and sulfosuccinate; an alkyl amine oxide and an alcohol ethoxylate surfactant having between 1-3 EO groups; or an alkyl amine oxide, and sulfosuccinate and an alcohol ethoxylate surfactant having between 1-3 EO groups.

12. The composition of claim 1, wherein the high foaming anionic surfactant comprises from about 0.5-60 wt-%, wherein the high foaming alcohol ethoxylate or alcohol alkoxylate surfactant comprises from about 0.1-25 wt-%, and the one or more co-surfactants comprises from about 0.1-20 wt-% of the composition.

13. The composition of claim 1, wherein the active weight percentage of nonionic surfactant exceeds the active weight percentage of anionic surfactant.

14. A method of using a 1,4 dioxane mitigated solid or liquid detergent composition comprising:
generating a use solution of the solid or liquid composition according to claim 1; and
contacting an article or surface in need of cleaning with the use solution.

15. The method of claim 14, wherein the detergent composition contains less than about 1 ppm of 1,4 dioxane.

16. The method of claim 14, wherein the article is ware, or wherein the article is ware comprising pots and/or pans.

17. The method of claim 14, further comprising a mechanical action step to remove soils and/or a rinsing step to remove the use solution from the article or surface.

18. The method of claim 14, wherein the use solution has a temperature of greater than about 35° C.

19. The method of claim 14, wherein the use solution provides from about 100 ppm to 5000 ppm of the detergent composition.

20. The method of claim 14, wherein the ratio of co-surfactants is selected for a desired viscosity range to dispense the solid or liquid composition or a use solution thereof from an inline dispensing system, and wherein the performance of the detergent is not adversely impacted by hard water.
